(19) United States
(12) Patent Application Publication
(10) Pub. No.: US 2020/0285235 A1
(43) Pub. Date: Sep. 10, 2020

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Katsuyasu Yamane, Wako-shi (JP); Yoshitaka Mimura, Wako-shi (JP); Hiroshi Yamanaka, Wako-shi (JP); Chie Sugihara, Tokyo (JP); Yuki Motegi, Tokyo (JP); Tsubasa Shibauchi, Tokyo (JP)

(21) Appl. No.: 16/805,891

(22) Filed: Mar. 2, 2020

(30) Foreign Application Priority Data
Mar. 7, 2019 (JP) 2019-041992

(51) Int. Cl. G05D 1/00; B60W 10/04; B60W 10/20; B60W 30/06; G06K 9/00

(52) U.S. Cl. CPC G05D 1/0088; B60W 10/04; B60W 10/20; B60W 30/06; G06K 9/00791; B60W 60/00253; B60W 2720/10; B60W 2720/12; B60W 2710/20; B60W 2540/041; G05D 2201/0213; G06K 9/00362

(57) ABSTRACT

A vehicle control device includes an acquirer configured to acquire a recognition result of a surroundings situation of a vehicle from a recognition device, and a driving controller configured to control steering and a speed of the vehicle on the basis of the recognition result to move the vehicle so that a user located in a boarding area is able to board the vehicle, and the driving controller is configured to stop the vehicle at a first stop position in a case in which the user has been recognized in the boarding area when the vehicle is moved to the boarding area, and is configured to stop the vehicle at a second stop position in a case in which the user has not been recognized in the boarding area when the vehicle is moved to the boarding area.

### CROSS-REFERENCE TO RELATED APPLICATION

Priority is claimed on Japanese Patent Application No. 2019-041992, filed Mar. 7, 2019, the content of which is incorporated herein by reference.

### BACKGROUND

### Field of the Invention

The present invention relates to a vehicle control device, a vehicle control method, and a storage medium.

### Description of Related Art

In recent years, research on automated driving of vehicles has been conducted. Meanwhile, a technology for providing a building with a first space for temporarily parking a car and a second space for moving the car parked in the first space and parking the car secondarily is known (see, for example, Japanese Unexamined Patent Application, First Publication No. 2012-144915). A technology for generating a traveling route from a parking position of a vehicle that a user visiting a parking lot for exit of the vehicle boards to a point closest to an automatic door provided in the parking lot when the user passes through the automatic door, and automatically driving the vehicle along the traveling route to move the vehicle to the point closest to the automatic door through which the user has passed is known (see, for example, Japanese Unexamined Patent Application, First Publication No. 2018-180831).

### SUMMARY

When the vehicle is moved to a boarding point of the user by automated driving as in the related art, it is assumed that other vehicles also move to the boarding point. In this case, because a plurality of vehicles gather around the boarding point, a traffic flow may be disrupted and it may be difficult for the user to board the vehicle. It is also assumed that the user who will board the vehicle has not yet arrived at the boarding point, and a position at which the vehicle will stop according to the presence or absence of the user at the boarding point has not been sufficiently studied.

An aspect of the present invention provides a vehicle control device, a vehicle control method, and a storage medium capable of moving a vehicle to a position at which it is easy for a user to board the vehicle and making a traffic flow smooth.

The vehicle control device, the vehicle control method, and the storage medium according to the present invention adopt the following configurations.

(1) An aspect of the present invention is a vehicle control device including: an acquirer configured to acquire a recognition result of a surroundings situation of a vehicle from a recognition device configured to recognize the surroundings situation of the vehicle; and a driving controller configured to control steering and a speed of the vehicle on the basis of the recognition result acquired by the acquirer, to move the vehicle so that a user located in a boarding area is able to board the vehicle, wherein the driving controller is configured to stop the vehicle at a first stop position according to a position of the user in the boarding area in a case in which a first recognition result indicating that the user has been recognized in the boarding area has been acquired by the acquirer when the vehicle is moved to the boarding area, and is configured to stop the vehicle at a second stop position according to a position of an entrance to a facility in the boarding area in a case in which a second recognition result indicating that the user has not been recognized in the boarding area has been acquired by the acquirer or in a case in which the first recognition result has not been acquired by the acquirer when the vehicle is moved to the boarding area.

According to an aspect (2), in the vehicle control device according to the first aspect, the driving controller is configured to determine a position at which a distance between the user and the vehicle is within a predetermined distance in the boarding area to be the first stop position.

According to an aspect (3), in the vehicle control device according to the aspect (1) or (2), in a case in which the acquirer has acquired a third recognition result indicating that an obstacle present ahead of the first stop position, the obstacle being an obstacle predicted to hinder travel of the vehicle when travel of the vehicle from the first stop position is started, has been recognized when the vehicle is stopped at the first stop position, the driving controller is configured to stop the vehicle at the first stop position in a first state in which a traveling direction of the vehicle intersects a direction in which a road on which the boarding area is present extends.

According to an aspect (4), in the vehicle control device according to the aspect (3), when a driving mode of the vehicle scheduled when travel of the vehicle from the first stop position is started is a manual driving mode in which steering and a speed of the vehicle are controlled by the user, the driving controller is configured to stop the vehicle at the first stop position in the first state.

According to an aspect (5), in the vehicle control device according to the aspect (3) or (4), when a driving mode of the vehicle scheduled when travel of the vehicle from the first stop position is started is an automated driving mode in which steering and a speed of the vehicle are controlled, the driving controller is configured to stop the vehicle at the first stop position in a second state in which the traveling direction of the vehicle does not intersect with the direction in which the road extends, unlike the first state.

According to an aspect (6), in the vehicle control device according to any one of the aspects (1) to (5), the recognition device is configured to recognize a surroundings situation of a second vehicle stopping in the boarding area, and when the vehicle overtakes the second vehicle after travel of the vehicle from the first stop position has been started, the driving controller is configured to determine a distance in a vehicle width direction between the vehicle and the second vehicle when the vehicle is caused to overtake the second vehicle on the basis of the surroundings situation of the second vehicle indicated by the recognition result.

According to an aspect (7), in the vehicle control device according to the aspect (6), in a case in which the acquirer has acquired a fourth recognition result indicating that a person is present around the second vehicle, including the inside of the second vehicle, the driving controller increases the distance in the vehicle width direction, as compared with a case in which the acquirer has acquired a fifth recognition result indicating that no person is present around the second vehicle, including the inside of the second vehicle or a case in which the acquirer has not been acquired the fourth recognition result.

According to an aspect (8), in the vehicle control device according to any one of the aspects (1) to (7), the recognition device is configured to recognize a surroundings situation of a second vehicle stopping in the boarding area, and when the vehicle overtakes the second vehicle after travel of the vehicle from the first stop position has been started, the driving controller is configured to determine a speed of the vehicle when the vehicle is caused to overtake the second vehicle on the basis of the surroundings situation of the second vehicle indicated by the recognition result.

According to an aspect (9), in the vehicle control device according to the aspect (8), in a case in which the acquirer has acquired a fourth recognition result indicating that a person is present around the second vehicle, including the inside of the second vehicle, the driving controller decreases the speed of the vehicle, as compared with a case in which the acquirer has acquired a fifth recognition result indicating that no person is present around the second vehicle, including the inside of the second vehicle or a case in which the acquirer has not been acquired the fourth recognition result.

According to an aspect (10), in the vehicle control device according to any one of the aspects (1) to (9), when the user does not board the vehicle until a first predetermined time elapses after the vehicle is stopped at the first stop position, the driving controller is configured to move the vehicle to a third stop position, the third stop position being a leading position in the boarding area and configured to stop the vehicle.

According to an aspect (11), in the vehicle control device according to the aspect (10), when the user does not board the vehicle until a second predetermined time elapses after the vehicle is stopped at the third stop position, the driving controller is configured to move the vehicle to a parking lot and parks the vehicle.

According to an aspect (12), in the vehicle control device according to any one of the aspects (1) to (11), the driving controller is configured to determine a further forward position in a traveling direction when the first stop position is present in front of the second vehicle stopping in the boarding area than when the first stop position is not present in front of the second vehicle, to be the first stop position.

According to an aspect (13), in the vehicle control device according to any one of the aspects (1) to (12), when the user does not board the vehicle after the vehicle is stopped at the second stop position, the driving controller repeatedly is configured to move the vehicle to a forward area in the boarding area and stop the vehicle until the user boards the vehicle.

According to an aspect (14), in the vehicle control device according to any one of the aspects (1) to (13), the boarding area includes a first area in which the user waits, and a second area in which the user is able to board the vehicle, and the driving controller is configured to move the vehicle to the second area.

According to an aspect (15), in the vehicle control device according to any one of the aspects (1) to (14), the recognition device includes at least one of a first recognition device mounted in the vehicle and a second recognition device installed in a site of a facility including the boarding area.

(16) Another aspect of the present invention is a vehicle control method including: acquiring, by a computer mounted in a vehicle, a recognition result of a surroundings situation of the vehicle from a recognition device configured to recognize the surroundings situation of the vehicle; controlling, by the computer, steering and a speed of the vehicle on the basis of the acquired recognition result, to move the vehicle so that a user located in a boarding area is able to board the vehicle; stopping, by the computer, the vehicle at a first stop position according to a position of the user in the boarding area in a case in which a first recognition result indicating that the user has been recognized in the boarding area has been acquired when the vehicle is moved to the boarding area, and stopping, by the computer, the vehicle at a second stop position according to a position of an entrance to a facility in the boarding area in a case in which a second recognition result indicating that the user has not been recognized in the boarding area has been acquired or in a case in which the first recognition result has not been acquired when the vehicle is moved to the boarding area.

(17) Still another aspect of the present invention is a non-transitory computer-readable storage medium storing a program, the program causing a computer mounted in a vehicle to execute: processes of acquiring a recognition result of a surroundings situation of the vehicle from a recognition device configured to recognize the surroundings situation of the vehicle; controlling steering and a speed of the vehicle on the basis of the acquired recognition result, moving the vehicle so that a user located in a boarding area is able to board the vehicle; stopping the vehicle at a first stop position according to a position of the user in the boarding area in a case in which a first recognition result indicating that the user has been recognized in the boarding area has been acquired when the vehicle is moved to the boarding area, and stopping the vehicle at a second stop position according to a position of an entrance to a facility in the boarding area in a case in which a second recognition result indicating that the user has not been recognized in the boarding area has been acquired or in a case in which the first recognition result has not been acquired when the vehicle is moved to the boarding area. According to any one of the aspects (1) to (17), it is possible to move a vehicle to a position at which it is easy for a user to board the vehicle and make a traffic flow smooth.

### BRIEF DESCRIPTION OF THE DRAWINGS

FIG. 1 is a configuration diagram of a vehicle system using a vehicle control device according to an embodiment.

FIG. 2 is a functional configuration diagram of a first controller, a second controller, and a third controller.

FIG. 3 is a diagram schematically showing a scene in which a self-traveling and parking event is executed.

FIG. 4 is a diagram showing an example of a configuration of a parking lot management device.

FIG. 5 is a flowchart showing an example of a series of processes of an automated driving control device according to the embodiment.

FIG. 6 is a flowchart showing an example of a series of processes of the automated driving control device according to the embodiment.

FIG. 7 is a diagram schematically showing a state in which a host vehicle is stopped at a closest-to-entrance position.

FIG. 8 is a diagram schematically showing a state in which a host vehicle is stopped at a closest-to-entrance position.

FIG. 9 is a diagram schematically showing a state in which the host vehicle is stopped at a closest-to-occupant position.

FIG. 10 is a diagram schematically showing a state in which the host vehicle is stopped at a closest-to-occupant position.

FIG. 11 is a diagram schematically showing a state in which the host vehicle is stopped at a closest-to-occupant position.

FIG. 12 is a diagram schematically showing a state in which the host vehicle is stopped at a closest-to-occupant position.

FIG. 13 is a diagram schematically showing a state in which the host vehicle is stopped at a closest-to-occupant position.

FIG. 14 is a diagram schematically showing a state in which the host vehicle is stopped at a closest-to-occupant position.

FIG. 15 is a diagram schematically showing a state in which the host vehicle is caused to overtake another stopped vehicle.

FIG. 16 is a diagram schematically showing a state in which the host vehicle is caused to overtake another stopped vehicle.

FIG. 17 is a diagram schematically showing a state in which a stop position of the host vehicle is changed in a stop area.

FIG. 18 is a diagram schematically showing a state in which a stop position of the host vehicle is changed in a stop area.

FIG. 19 is a diagram schematically showing a state in which a stop position of the host vehicle is changed in a stop area.

FIG. 20 is a diagram schematically showing a state in which the automated driving control device controls the host vehicle using a recognition result of an external recognition device.

FIG. 21 is a diagram showing an example of a hardware configuration of the automated driving control device according to the embodiment.

### DESCRIPTION OF EMBODIMENTS

Hereinafter, embodiments of a vehicle control device, a vehicle control method, and a storage medium of the present invention will be described with reference to the drawings.

### [Overall Configuration]

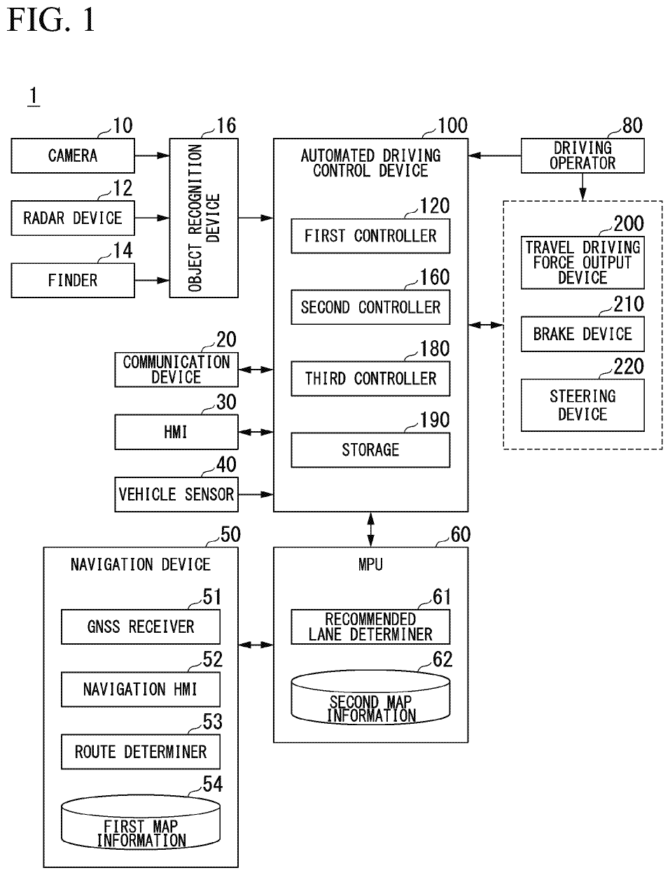

FIG. 1 is a configuration diagram of a vehicle system 1 using a vehicle control device according to an embodiment. A vehicle in which the vehicle system 1 is mounted is, for example, a vehicle such as a two-wheeled vehicle, a three-wheeled vehicle, or a four-wheeled vehicle. A driving source thereof includes an internal combustion engine such as a diesel engine or a gasoline engine, an electric motor, or a combination thereof. The electric motor operates using power generated by a power generator connected to the internal combustion engine or discharge power of a secondary battery or a fuel cell.

The vehicle system 1 includes, for example, a camera 10, a radar device 12, a finder 14, an object recognition device 16, a communication device 20, a person machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. These devices or equipment are connected to each other by a multiplex communication line such as a controller area network (CAN) communication line, a serial communication line, a wireless communication network, or the like. The configuration shown in FIG. 1 is merely an example, and a part of the configuration may be omitted or another configuration may be added.

The camera 10 is, for example, a digital camera using a solid-state imaging device such as a charge coupled device (CCD) or a complementary metal oxide semiconductor (CMOS). The camera 10 is attached to any place on a vehicle in which the vehicle system 1 is mounted (hereinafter, a host vehicle M). In the case of forward imaging, the camera 10 is attached to an upper portion of a front windshield, a rear surface of a rearview mirror, or the like. The camera 10, for example, periodically and repeatedly images surroundings of the host vehicle M. The camera 10 may be a stereo camera.

The radar device 12 radiates radio waves such as millimeter waves to the surroundings of the host vehicle M and detects radio waves (reflected waves) reflected by an object to detect at least a position (a distance and orientation) of the object. The radar device 12 is attached to any place on the host vehicle M. The radar device 12 may detect a position and a speed of the object using a frequency modulated continuous wave (FM-CW) scheme.

The finder 14 is a light detection and ranging (LIDAR). The finder 14 radiates light to the surroundings of the host vehicle M and measures scattered light. The finder 14 detects a distance to a target on the basis of a time from light emission to light reception. The radiated light is, for example, pulsed laser light. The finder 14 is attached to any place on the host vehicle M.

The object recognition device 16 performs a sensor fusion process on detection results of some or all of the camera 10, the radar device 12, and the finder 14 to recognize a position, type, speed, and the like of the object. The object recognition device 16 outputs recognition results to the automated driving control device 100. The object recognition device 16 may output the detection results of the camera 10, the radar device 12, and the finder 14 as they are to the automated driving control device 100. The object recognition device 16 may be omitted from the vehicle system 1.

The communication device 20, for example, communicates with a second vehicle (another vehicle) present around the host vehicle M or a parking lot management device (to be described below), or various server devices using a cellular network, a Wi-Fi network, Bluetooth (registered trademark), dedicated short range communication (DSRC), or the like.

The HMI 30 presents various types of information to an occupant of the host vehicle M and receives an input operation from the occupant. The HMI 30 includes a display, speakers, buzzers, touch panels, switches, keys, and the like.

The vehicle sensor 40 includes, for example, a vehicle speed sensor that detects a speed of the host vehicle M, an acceleration sensor that detects an acceleration, a yaw rate sensor that detects an angular speed around a vertical axis, and an orientation sensor that detects a direction of the host vehicle M.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 specifies a position of the host vehicle M on the basis of a signal received from a GNSS satellite. The position of the host vehicle M may be specified or supplemented by an inertial navigation system (INS) using an output of the vehicle sensor 40. The navigation HMI 52 includes a display, a speaker, a touch panel, keys, and the like. The navigation HMI 52 may be partly or wholly shared with the HMI 30 described above. The route determiner 53, for example, determines a route (hereinafter, an on-map route) from the position of the host vehicle M specified by the GNSS receiver 51 (or any input position) to a destination input by the occupant using the navigation HMI 52 by referring to the first map information 54. The first map information 54 is, for example, information in which a road shape is represented by links indicating roads and nodes connected by the links. The first map information 54 may include a curvature of the road, point of interest (POI) information, and the like. The on-map route is output to the MPU 60. The navigation device 50 may perform route guidance using the navigation HMI 52 on the basis of the on-map route. The navigation device 50 may be realized, for example, by a function of a terminal device such as a smartphone or a tablet terminal possessed by the occupant. The navigation device 50 may transmit a current position and a destination to a navigation server via the communication device 20 and acquire the same route as the on-map route from the navigation server.

The MPU 60 includes, for example, a recommended lane determiner 61, and holds second map information 62 in a storage device such as an HDD or a flash memory. The recommended lane determiner 61 divides the on-map route provided from the navigation device 50 into a plurality of blocks (for example, divides the route every 100 [m] in a traveling direction of the vehicle), and determines a recommended lane for each block by referring to the second map information 62. The recommended lane determiner 61 determines in which lane from the left the host vehicle M travels. The recommended lane determiner 61 determines the recommended lane so that the host vehicle M can travel on a reasonable route for travel to a branch destination when there is a branch place in the on-map route.

The second map information 62 is map information with higher accuracy than the first map information 54. The second map information 62 includes, for example, information on a center of the lane or information on a boundary of the lane. Further, the second map information 62 may include road information, traffic regulation information, address information (an address and postal code), facility information, telephone number information, and the like. The second map information 62 may be updated at any time by the communication device 20 communicating with another device.

The driving operator 80 includes, for example, an accelerator pedal, a brake pedal, a shift lever, a steering wheel, a variant steer, a joystick, and other operators. A sensor that detects the amount of operation or the presence or absence of operation is attached to the driving operator 80, and a detection result thereof is output to the automated driving control device 100 or some or all of the travel driving force output device 200, the brake device 210, and the steering device 220.

The automated driving control device 100 includes, for example, a first controller 120, a second controller 160, a third controller 180, and a storage 190. Some or all of the first controller 120, the second controller 160, and the third controller 180 are realized, for example, by a processor such as a central processing unit (CPU) or a graphics processing unit (GPU) executing a program (software). Some or all of these components may be realized by hardware (a circuit portion; including circuitry) such as a large scale integration (LSI), an application specific integrated circuit (ASIC), or a field-programmable gate array (FPGA) or may be realized by software and hardware in cooperation. The program may be stored in an HDD, a flash memory, or the like of the storage 190 in advance or may be stored in a detachable storage medium such as a DVD or a CD-ROM and installed in the storage 190 by the storage medium being mounted in a drive device.

The storage 190 is realized by, for example, an HDD, a flash memory, an electrically erasable programmable read-only memory (EEPROM), a read only memory (ROM), or a random access memory (RAM). The storage 190 stores, for example, a program that is read and executed by a processor.

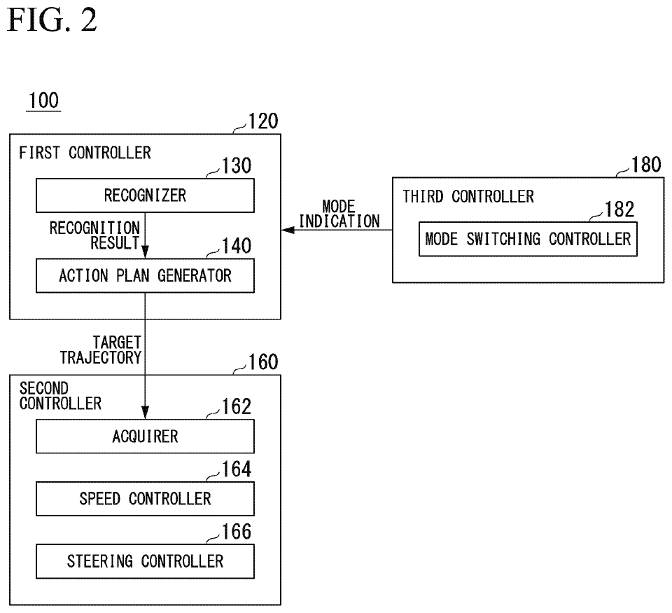

FIG. 2 is a functional configuration diagram of the first controller 120, the second controller 160, and the third controller 180. The first controller 120 includes, for example, a recognizer 130 and an action plan generator 140. A combination of the camera 10, the radar device 12, the finder 14, the object recognition device 16, and the recognizer 130 is an example of a “first recognition device”. The action plan generator 140 is an example of an “acquirer”.

The first controller 120 realizes, for example, a function using artificial intelligence (AI) and a function using a previously given model in parallel. For example, a function of “recognizing an intersection” may be realized by recognition of the intersection using deep learning or the like and recognition based on previously given conditions (there is a signal which can be subjected to pattern matching, a road sign, or the like) being executed in parallel and scored for comprehensive evaluation. Accordingly, the reliability of automated driving is guaranteed.

The recognizer 130 recognizes a surroundings situation of the host vehicle M on the basis of information input from the camera 10, the radar device 12, and the finder 14 via the object recognition device 16, that is, a detection result subjected to sensor fusion. For example, the recognizer 130 recognizes a state such as a position, speed, or acceleration of an object present around the host vehicle M, as the surroundings situation. Examples of the object recognized as the surroundings situation include moving objects such as pedestrians or other vehicles, or a stationary body such as such as construction tools. The position of the object, for example, is recognized as a position at coordinates with a representative point (a centroid, a drive shaft center, or the like) of the host vehicle M as an origin, and is used for control. The position of the object may be represented by a representative point such as a centroid or a corner of the object or may be represented by an area having a spatial extent. The “state” of the object may include an acceleration or jerk of the object, or an “action state” (for example, whether or not the object is changing lanes or is about to change lanes).

Further, for example, the recognizer 130 recognizes a lane in which the host vehicle M is traveling (hereinafter referred to as a host lane), an adjacent lane adjacent to the host lane, or the like as the surroundings situation. For example, the recognizer 130 compares a pattern of a road marking line (for example, an arrangement of a solid line and a broken line) obtained from the second map information 62 with a pattern of a road marking line around the host vehicle M recognized from an image captured by the camera 10 to recognize the host lane or the adjacent lane. The recognizer 130 may recognize not only the road marking lines but also a traveling road boundary (a road boundary) including a road shoulder, a curb, a median strip, a guard rail, or the like to recognize the host lane or the adjacent lane. In this recognition, the position of the host vehicle M acquired from the navigation device 50 or a processing result of an INS may be additionally considered. The recognizer 130 may recognize a sidewalk, a stop line (including a temporary stop line), an obstacle, a red light, a toll gate, a road structure, and other road events.

The recognizer 130 recognizes a relative position or posture of the host vehicle M with respect to a host lane when recognizing the host lane. The recognizer 130 may recognize, for example, a deviation of a reference point of the host vehicle M with respect to a center of the lane and an angle formed between a vector indicating a traveling direction of the host vehicle M and a line connecting the center of the lane as the relative position and posture of the host vehicle M with respect to the host lane. Instead, the recognizer 130 may recognize, for example, a position of the reference point of the host vehicle M with respect to any one of side end portions (the road marking line or the road boundary) of the host lane as the relative position of the host vehicle M with respect to the host lane.

The action plan generator 140 determines an automated driving event in a route in which the recommended lane has been determined. The automated driving event is information defining an aspect of a behavior to be taken by the host vehicle M under the automated driving, that is, a traveling aspect. The automated driving means that at least one of a speed and steering of the host vehicle M is controlled or both are controlled without depending on a driving operation of a driver of the host vehicle M. On the other hand, the manual driving means that the steering of the host vehicle M is controlled by the driver of the host vehicle M operating a steering wheel, and the speed of the host vehicle M is controlled by the driver operating an accelerator pedal or a brake pedal.

An event includes, for example, a parking event. The parking event is an event in which the occupant of the host vehicle M does not park the host vehicle M in a parking space, but the host vehicle M is caused to autonomously travel and parked in the parking space, as in valet parking. The event may include a constant speed traveling event, a following traveling event, a lane change event, a branch event, a merging event, an overtaking event, an avoidance event, a takeover event, and the like, in addition to the parking event. The constant speed traveling event is an event in which the host vehicle M is caused to travel in the same lane at a constant speed. The following traveling event is an event in which a vehicle present within a predetermined distance (for example, within 100 [m]) ahead of the host vehicle M and closest to the host vehicle M (hereinafter referred to as a preceding vehicle) is caused to follow the host vehicle M. “Following” may be, for example, a traveling aspect in which a relative distance (an inter-vehicle distance) between the host vehicle M and the preceding vehicle is kept constant, or may be a traveling aspect in which the host vehicle M is caused to travel in a center of the host lane, in addition to the relative distance between the host vehicle M and the preceding vehicle being kept constant. The lane change event is an event in which the host vehicle M is caused to change lanes from the host lane to an adjacent lane. The branching event is an event in which the host vehicle M is caused to branch to a lane on the destination side at a branch point on a road. The merging event is an event in which the host vehicle M is caused to merge with a main lane at a merging point. The overtaking event is an event in which the host vehicle M is first caused to perform lane change to an adjacent lane, overtake a preceding vehicle in the adjacent lane, and then, perform lane change to an original lane again. The avoidance event is an event in which the host vehicle M is caused to perform at least one of braking and steering in order to avoid an obstacle present in front of the host vehicle M. The takeover event is an event in which the automated driving ends and switching to the manual driving occurs.

Further, the action plan generator 140 may change an event already determined for a current section or a next section to another event or determine a new event for the current section or the next section according to the surroundings situation recognized by the recognizer 130 when the host vehicle M is traveling.

The action plan generator 140 generates a future target trajectory in which the host vehicle M will travel in the recommended lane determined by the recommended lane determiner 61 in principle, and the host vehicle M is caused to travel automatically (without depending on a driver's operation) in a traveling aspect defined by the events in order to cope with the surroundings situation when the host vehicle M travels in the recommended lane. The target trajectory includes, for example, a position element that defines a future position of the host vehicle M, and a speed element that defines a future speed, acceleration, or the like of the host vehicle M.

For example, the action plan generator 140 determines a plurality of points (trajectory points) that the host vehicle M is to reach in order, as the position elements of the target trajectory. The trajectory point is a point that the host vehicle M is to reach for each predetermined traveling distance (for example, several [m]). The predetermined traveling distance may be calculated, for example, using a road distance when the host vehicle M travels along the route.

The action plan generator 140 determines a target speed or a target acceleration at every predetermined sampling time (for example, every several tenths of a second) as the speed elements of the target trajectory. The trajectory points for each sampling time may be positions that the host vehicle M will reach at predetermined sampling times. In this case, the target speed or the target acceleration is determined using the sampling time and an interval between the trajectory points. The action plan generator 140 outputs information indicating the generated target trajectory to the second controller 160.

The second controller 160 controls some or all of the travel driving force output device 200, the brake device 210, and the steering device 220 so that the host vehicle M passes through the target trajectory generated by the action plan generator 140 at a scheduled time. That is, the second controller 160 automatically drives the host vehicle M on the basis of the target trajectory generated by the action plan generator 140.

The second controller 160 includes, for example, an acquirer 162, a speed controller 164, and a steering controller 166. A combination of the action plan generator 140 and the second controller 160 is an example of a “driving controller”.

The acquirer 162 acquires information on the target trajectory (trajectory points) generated by the action plan generator 140 and stores the information on the target trajectory in a memory of the storage 190.

The speed controller 164 controls one or both of the travel driving force output device 200 and the brake device 210 on the basis of the speed element (for example, the target speed or target acceleration) included in the target trajectory stored in the memory.

The steering controller 166 controls the steering device 220 according to the position element (for example, a curvature indicating a degree of curvature of the target trajectory) included in the target trajectory stored in the memory.

Processes of the speed controller 164 and the steering controller 166 are realized by, for example, a combination of feedforward control and feedback control. For example, the steering controller 166 executes a combination of feedforward control according to a curvature of a road in front of the host vehicle M and feedback control based on a deviation of the host vehicle M with respect to the target trajectory.

The travel driving force output device 200 outputs a travel driving force (torque) for traveling of the vehicle to the driving wheels. The travel driving force output device 200 includes, for example, a combination of an internal combustion engine, an electric motor, a transmission, and the like, and a power electronic control unit (ECU) that controls these. The power ECU controls the above configuration according to information input from the second controller 160 or information input from the driving operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor according to information input from the second controller 160 or information input from the driving operator 80 so that a brake torque according to a braking operation is output to each wheel. The brake device 210 may include a mechanism that transfers the hydraulic pressure generated by the operation of the brake pedal included in the driving operator 80 to the cylinder via a master cylinder, as a backup. The brake device 210 is not limited to the configuration described above and may be an electronically controlled hydraulic brake device that controls the actuator according to information input from the second controller 160 and transfers the hydraulic pressure of the master cylinder to the cylinder.

The steering device 220 includes, for example, a steering ECU and an electric motor. The electric motor, for example, changes a direction of the steerable wheels by causing a force to act on a rack and pinion mechanism. The steering ECU drives the electric motor according to information input from the second controller 160 or information input from the driving operator 80 to change the direction of the steerable wheels.

The third controller 180 includes, for example, a mode switching controller 182. The mode switching controller 182 switches a driving mode of the host vehicle M to any one of an automated driving mode and a manual driving mode on the basis of a recognition result of the recognizer 130, a type of event determined by the action plan generator 140, an operation of the occupant with respect to the HMI 30, an operation of the occupant with respect to the driving operator 80, and the like. The automated driving mode is a mode in which the automated driving described above is performed, and the manual driving mode is a mode in which the manual driving described above is performed.

For example, when the occupant has operated the HMI 30 to reserve a timing for switching from the automated driving mode to the manual driving mode or a timing for switching from the manual driving mode to the automated driving mode, the mode switching controller 182 switches between the driving modes of the host vehicle M in response to this reservation.

### [Self-Traveling and Parking Event—at the Time of Entry]

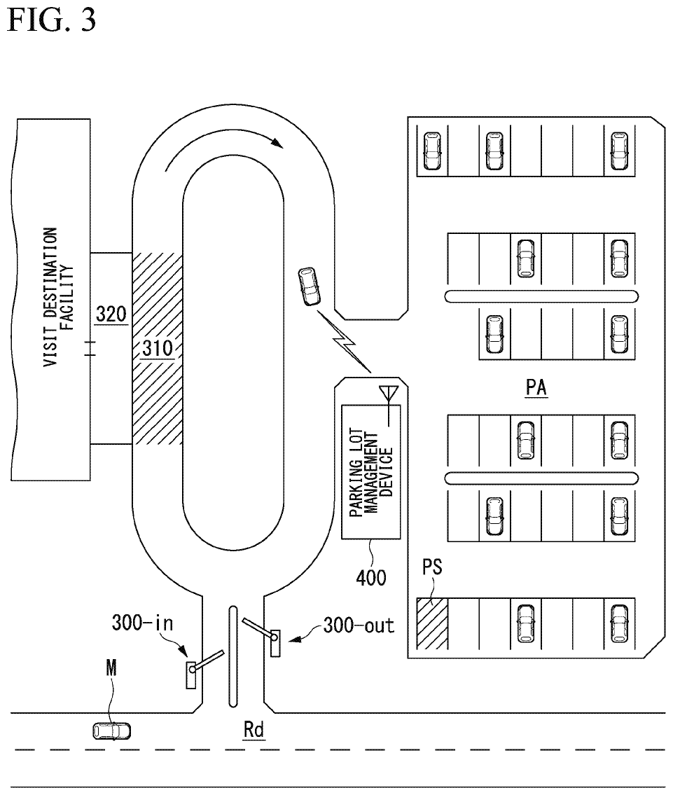

Hereinafter, a function of the action plan generator 140 that has executed the self-traveling and parking event will be described. The action plan generator 140 that has executed the self-traveling and parking event parks the host vehicle M in the parking space on the basis of information acquired from a parking lot management device 400 by the communication device 20, for example. FIG. 3 is a diagram schematically showing a scene in which the self-traveling and parking event is executed. Gates 300-in and 300-out are provided on a route from a road Rd to the visit destination facility. The visit destination facility includes, for example, shopping stores, restaurants, accommodation facilities such as hotels, airports, hospitals, and event venues.

The host vehicle M passes through the gate 300-in and travels to the stop area 310 through manual driving or automated driving.

The stop area 310 is an area that faces the boarding and alighting area 320 connected to the visit destination facility, and in which a vehicle is allowed to temporarily stop in order to drop an occupant at the boarding and alighting area 320 from the vehicle or cause the occupant to board the vehicle from the boarding and alighting area 320. The boarding and alighting area 320 is an area provided so that an occupant may alight from a vehicle, board a vehicle, or waits at that point until a vehicle arrives. The boarding and alighting area 320 is typically provided on one side of a road on which the stop area 310 has been provided. An eave for avoidance of rain, snow, and sunlight may be provided in the boarding and alighting area 320. An area including the stop area 310 and the boarding and alighting area 320 is an example of a “boarding area”. The stop area 310 is an example of a “second area”, and the boarding and alighting area 320 is an example of a “first area”.

For example, the host vehicle M that an occupant has boarded stops at the stop area 310 and drops the occupant at the boarding and alighting area 320. Thereafter, the host vehicle M performs automated driving in an unmanned manner, and starts a self-traveling and parking event in which the host vehicle M autonomously moves from the stop area 310 to the parking space PS in the parking lot PA. A start trigger of the self-traveling and parking event, for example, may be that the host vehicle M has approached to within a predetermined distance from the visit destination facility, may be that the occupant has activated a dedicated application in a terminal device such as a mobile phone, or may be that the communication device 20 has wirelessly received a predetermined signal from the parking lot management device 400.

When the self-traveling and parking event starts, the action plan generator 140 controls the communication device 20 so that a parking request is transmitted to the parking lot management device 400. When there is a space in the parking lot PA in which the vehicle can be parked, the parking lot management device 400 that has received the parking request transmits a predetermined signal as a response to the parking request to the vehicle, which is a transmission source of the parking request. The host vehicle M that has received the predetermined signal moves from the stop area 310 to the parking lot PA according to guidance of the parking lot management device 400 or while performing sensing by itself. When the self-traveling and parking event is performed, the host vehicle M does not necessarily have to be unmanned, and a staff member of the parking lot PA may board the host vehicle M.

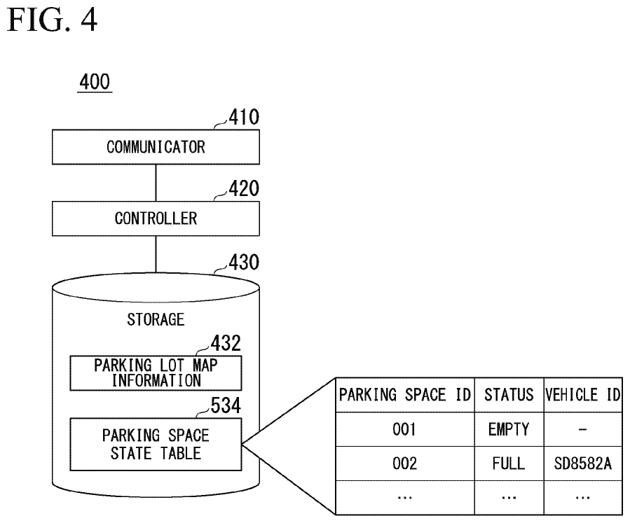

FIG. 4 is a diagram showing an example of a configuration of the parking lot management device 400. The parking lot management device 400 includes, for example, a communicator 410, a controller 420, and a storage 430. The storage 430 stores information such as parking lot map information 432 and a parking space status table 434.

The communicator 410 wirelessly communicates with the host vehicle M or other vehicles. The controller 420 guides the vehicle to the parking space PS on the basis of the information acquired (received) by communicator 410 and the information stored in storage 430. The parking lot map information 432 is information that geometrically represents a structure of the parking lot PA, and includes, for example, coordinates for each parking space PS. The parking space status table 434 is, for example, a table in which a status indicating whether the parking space is in an empty status in which no vehicle is parked in a parking space indicated by a parking space ID, which is identification information of the parking space PS or a full (parked) status in which a vehicle is parked in the parking space indicated by the parking space ID, and a vehicle ID that is identification information of parked vehicles when the parking space is in the full status are associated with the parking space ID.

When the communicator 410 receives the parking request from the vehicle, the controller 420 extracts the parking space PS that is in an empty status by referring to the parking space status table 434, acquires a position of the extracted parking space PS from the parking lot map information 432, and transmits route information indicating a suitable route to the acquired position of the parking space PS to the vehicle using the communicator 410. The controller 420 may instruct a specific vehicle to stop or instruct a specific vehicle to slow down, as necessary, on the basis of positional relationships between a plurality of vehicles so that the vehicles do not travel to the same position at the same time.

When the host vehicle M receives the route information from the parking lot management device 400, the action plan generator 140 generates a target trajectory based on the route. For example, the action plan generator 140 may generate a target trajectory in which a speed lower than a speed limit in the parking lot PA has been set as the target speed, and trajectory points have been arranged at a center of the road in the parking lot PA on a route from a current position of the host vehicle M to the parking space PS. When the host vehicle M approaches the parking space PS that is a target, the recognizer 130 recognizes parking frame lines or the like that partition the parking space PS, and recognizes a relative position of the parking space PS with respect to the host vehicle M. When the recognizer 130 has recognized the position of the parking space PS, the recognizer 130 provides a recognition result such as a direction of the recognized parking space PS (a direction of the parking space when viewed from the host vehicle M) or a distance to the parking space PS, to the action plan generator 140. The action plan generator 140 corrects the target trajectory on the basis of the provided recognition result. The second controller 160 controls the steering and the speed of the host vehicle M according to the target trajectory corrected by the action plan generator 140, so that the host vehicle M is parked in the parking space PS.

### [Self-Traveling and Parking Event—at the Time of Exit]

The action plan generator 140 and the communication device 20 remain in an operating state even when the host vehicle M is parked. For example, it is assumed that the occupant who has alighted from the host vehicle M operates the terminal device to activate a dedicated application and transmits a vehicle pick-up request to the communication device 20 of the host vehicle M. The vehicle pick-up request is a command for calling the host vehicle M from a remote place away from the host vehicle M and requesting the host vehicle M to move to a position close to the occupant.

When the vehicle pick-up request is received by the communication device 20, the action plan generator 140 executes the self-traveling and parking event. The action plan generator 140 that has executed the self-traveling and parking event generates a target trajectory for moving the host vehicle M from the parking space PS in which the host vehicle M has been parked, to the stop area 310. The second controller 160 moves the host vehicle M to the stop area 310 according to the target trajectory generated by the action plan generator 140. For example, the action plan generator 140 may generate a target trajectory in which a speed lower than the speed limit in the parking lot PA has been set as the target speed, and trajectory points have been arranged at the center of the road in the parking lot PA on the route to the stop area 310.

When the host vehicle M approaches the stop area 310, the recognizer 130 recognizes the boarding and alighting area 320 facing the stop area 310 and recognizes an object such as a person or luggage present in the boarding and alighting area 320. Further, the recognizer 130 recognizes the occupant of the host vehicle M from one or more persons present in the boarding and alighting area 320. For example, when a plurality of persons are present in the boarding and alighting area 320 and a plurality of occupant candidates are present, the recognizer 130 may distinguish the occupant of the host vehicle M from other occupants on the basis of a radio wave intensity of the terminal device held by the occupant of the host vehicle M or a radio wave intensity of an electronic key with which the host vehicle M can be locked or unlocked, and recognize the occupants. For example, the recognizer 130 may recognize a person with a strongest radio wave intensity as the occupant of the host vehicle M. The recognizer 130 may distinguish and recognize the occupant of the host vehicle M from the other occupants on the basis of feature amounts of faces of the respective occupant candidates, or the like. When the host vehicle M approaches the occupant of the host vehicle M, the action plan generator 140 further decreases the target speed or moves the trajectory points from the center of the road to a position close to the boarding and alighting area 320 to correct the target trajectory. Then, the second controller 160 stops the host vehicle M on the boarding and alighting area 320 side in the stop area 310.

When the action plan generator 140 generates the target trajectory in response to the vehicle pick-up request, the action plan generator 140 controls the communication device 20 such that a travel start request is transmitted to the parking lot management device 400. When the travel start request is received by the communicator 410, the controller 420 of the parking lot management device 400 instructs a specific vehicle to stop or slow down, as necessary, so that vehicles do not travel to the same position at the same time on the basis of the positional relationship between a plurality of vehicles, as in the time of the entry. When the host vehicle M moves to the stop area 310 and the occupant in the boarding and alighting area 320 boards the host vehicle M, the action plan generator 140 ends the self-traveling and parking event. Thereafter, the automated driving control device 100 plans, for example, a merging event in which the host vehicle M merges from the parking lot PA to a road in a city area and performs automated driving on the basis of the planned event, or the occupant himself or herself manually drives the host vehicle M.

The present invention is not limited to the above, and the action plan generator 140 may find the parking space PS in an empty status by itself on the basis of detection results of the camera 10, the radar device 12, the finder 14, or the object recognition device 16 without depending on communication, and park the host vehicle M in the found parking space.

### [Process Flow at the Time of Exit]

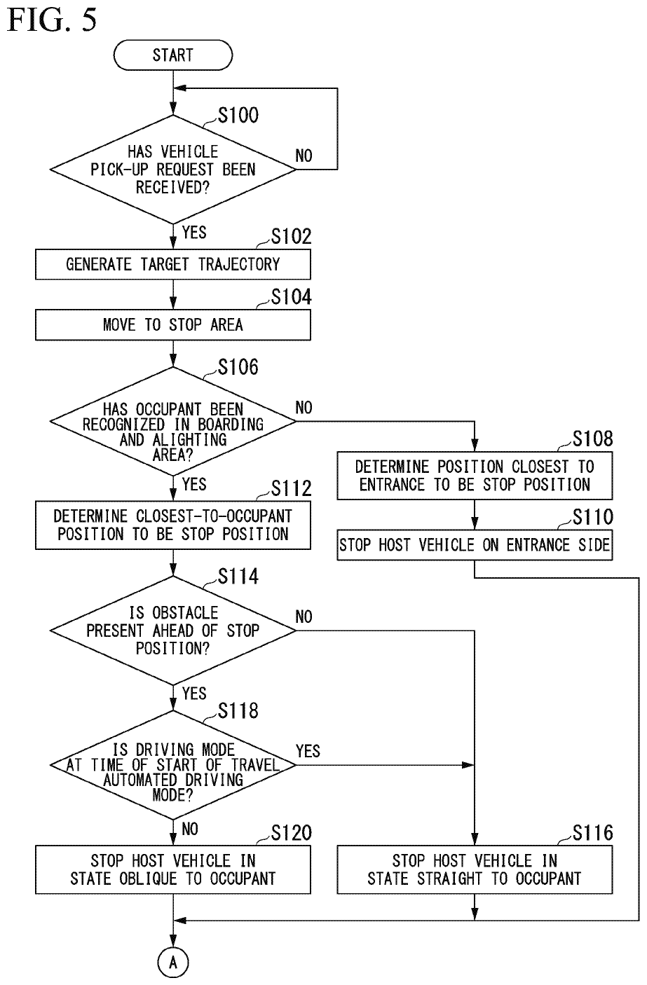

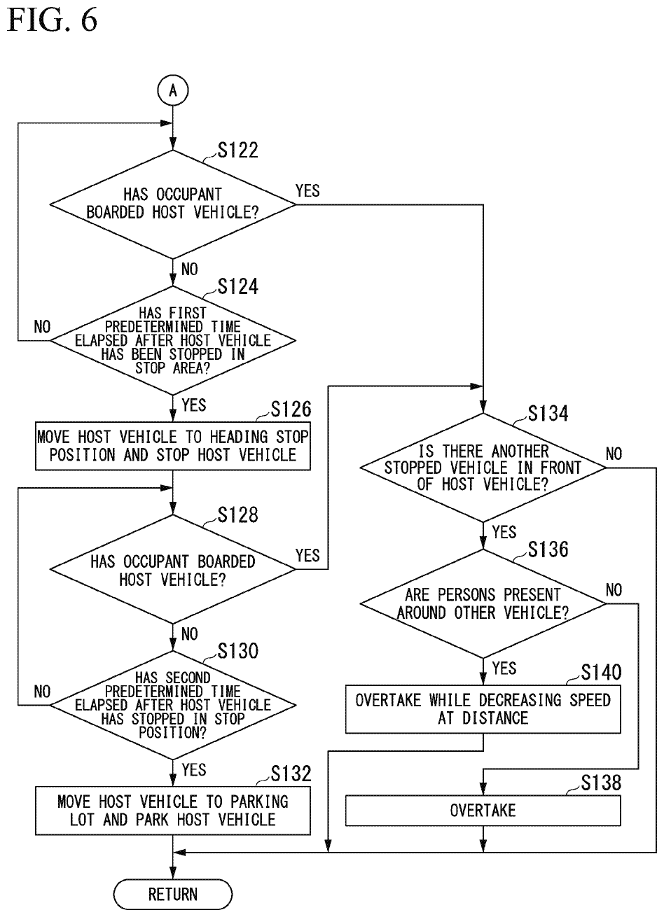

Hereinafter, a series of processes of the automated driving control device 100 at the time of exit will be described with reference to a flowchart. FIGS. 5 and 6 are flowcharts showing an example of the series of processes of the automated driving control device 100 according to the embodiment. A process of the flowchart may be repeatedly performed in a predetermined cycle in the automated driving mode, for example. It is assumed that the recognizer 130 continues to perform various recognitions unless otherwise specified while the process of the flowchart is being performed.

First, the action plan generator 140 waits until the vehicle pick-up request is received by the communication device 20 (step S100). When the vehicle pick-up request is received by the communication device 20, the action plan generator 140 determines an event of a route to the stop area 310 to be a self-traveling and parking event, and starts the self-traveling and parking event. The action plan generator 140 may start the self-traveling and parking event according to a vehicle pick-up time reserved by the occupant in advance instead of or in addition to starting the self-traveling and parking event after the vehicle pick-up request is received by the communication device 20. The action plan generator 140 generates a target trajectory for moving the host vehicle M from the parking space PS in which the host vehicle M has been parked to the stop area 310 (step S102).

Then, the second controller 160 performs automated driving on the basis of the target trajectory generated by the action plan generator 140 when the vehicle pick-up request has been received, to move the host vehicle M to the stop area 310 (step S104).

Then, the action plan generator 140 acquires the recognition result from the recognizer 130, and refers to the acquired recognition result to determine whether or not the occupant of the host vehicle M has been recognized in the boarding and alighting area 320 by the recognizer 130. (step S106).

For example, when the recognition result acquired from the recognizer 130 is a recognition result indicating that the occupant of the host vehicle M is present in the boarding and alighting area 320 (an example of a first recognition result), the action plan generator 140 determines that the occupant of the host vehicle M has been recognized in the boarding and alighting area 320.

For example, when the action plan generator 140 has acquired, from the recognizer 130, the recognition result (an example of the first recognition result) indicating that the occupant of the host vehicle M is present in the boarding and alighting area 320 during a period in which the host vehicle M is moving to the stop area 310, the action plan generator 140 determines that the occupant of the host vehicle M has been recognized in the boarding and alighting area 320.

For example, when the action plan generator 140 has acquired, from the recognizer 130, a recognition result (an example of a second recognition result) indicating that the occupant of the host vehicle M is not present in the boarding and alighting area 320 during a period in which the host vehicle M is moving to the stop area 310, the action plan generator 140 determines that the occupant of the host vehicle M has not been recognized in the boarding and alighting area 320. For example, when the action plan generator 140 has not acquired, from the recognizer 130, a recognition result indicating that the occupant of the host vehicle M is present in the boarding and alighting area 320 (an example of the second recognition result) during a period in which the host vehicle M is moving to the stop area 310, the action plan generator 140 may determine that the occupant of the host vehicle M has not been recognized in the boarding and alighting area 320.

When the action plan generator 140 has determined that the occupant of the host vehicle M has not been recognized in the boarding and alighting area 320, the action plan generator 140 determines a position closest to an entrance of a visit destination facility (hereinafter referred to as a closest-to-entrance position SP_{A}) in the stop area 310 from the current position of the host vehicle M to be a stop position at which the host vehicle M will stop in the stop area 310 (step S108). The closest-to-entrance position SP_{A} may be a position biased toward the boarding and alighting area 320 when viewed from the center of the road in which the stop area 310 has been provided. The closest-to-entrance position SP_{A} is an example of a “second stop position”.

Next, the action plan generator 140 generates a target trajectory to the closest-to-entrance position SP_{A} determined to be the stop position. Then, the second controller 160 stops the host vehicle M at the closest-to-entrance position SP_{A} according to the target trajectory (step S110).

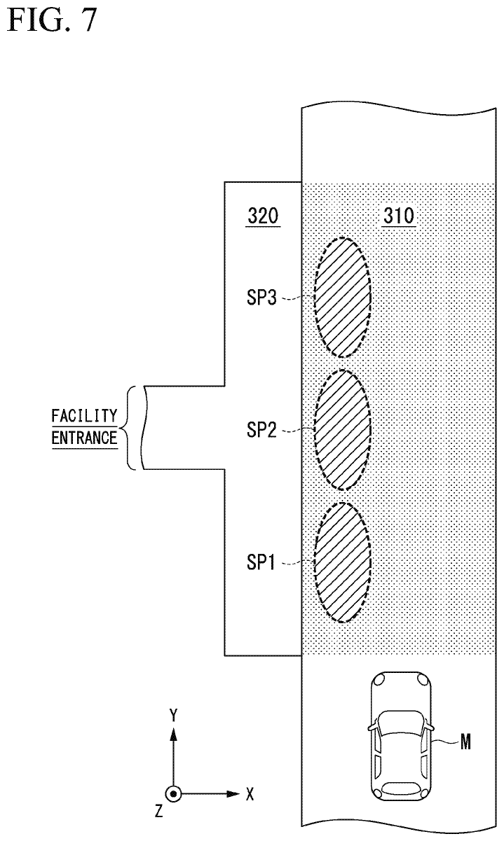

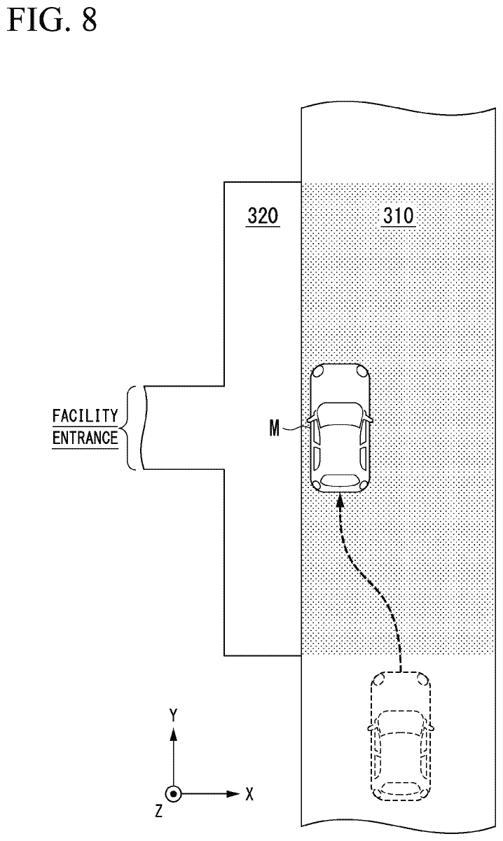

FIGS. 7 and 8 are diagrams schematically showing a state in which the host vehicle M is stopped at the closest-to-entrance position SP_{A}. In FIGS. 7 and 8, each of SP1 to SP3 is a stop position candidate. In FIGS. 7 and 8, Y indicates a direction in which the road in which the stop area 310 is present extends (a longitudinal direction of the road), X indicates a width direction of the road in which the stop area 310 is present (a lateral direction of the road), and Z indicates a vertical direction.

In the example shown in FIGS. 7 and 8, because no users are present in the boarding and alighting area 320, the recognizer 130 does not recognize the occupant of the host vehicle M in the boarding and alighting area 320. In this case, the action plan generator 140 determines a position SP2 closest to the entrance of the visit destination facility among three candidates for the stop position to be the closest-to-entrance position SP_{A}, and generates a target trajectory to the position SP2 determined to be the closest-to-entrance position SP_{A}. Then, the second controller 160 moves the host vehicle M to the position SP2 and stops the host vehicle M at the position SP2. Thus, when the host vehicle M has arrived at the stop area 310 before the occupant who has called the host vehicle M from a remote place away from the host vehicle M arrives at the boarding and alighting area 320, the host vehicle M is stopped at the position closest to the entrance of the visit destination facility. Thus, an occupant exiting the visit destination facility can board the host vehicle M on the shortest route.

When the recognizer 130 has recognized that a second vehicle has already stopped in the stop area 310 at a point in time when the host vehicle M has arrived at the stop area 310, the action plan generator 140 may determine a candidate of a position at which the second vehicle has not stopped and that is closest to the entrance of the visit destination facility among a plurality of candidates for a stop position, to be the closest-to-entrance position SP_{A}.

For example, when there are two candidates A and B for the stop position at positions at substantially the same distance from the entrance of the visit destination facility as candidates for the position closest to the entrance of the visit destination facility, the action plan generator 140 determines the closest-to-entrance position SP_{A} according to the following conditions. It is assumed that one candidate A for the stop position is present ahead of the other candidate B for a stop position in the traveling direction when viewed from the host vehicle M.

Condition (1): When a second vehicle has already stopped at any one of the two candidates A and B for the stop position, a position behind the second vehicle that has stopped at the candidate A for the stop position close to the host vehicle M is determined to be the closest-to-entrance position SP_{A}.

Condition (2): When other vehicles have not stopped at any of the two candidates A and B for the stop position, the candidate B for the stop position farther from the host vehicle M is determined to be the closest-to-entrance position SP_{A}.

Description of the flowcharts in FIGS. 5 and 6 will be returned to. On the other hand, when the action plan generator 140 has determined that the occupant of the host vehicle M has been recognized in the boarding and alighting area 320, the action plan generator 140 determines a position at which a distance between the occupant and the host vehicle M in the stop area 310 is within a predetermined distance (for example, several meters) (hereinafter referred to as a closest-to-occupant position SP_{B}) to be the stop position (step S112). The closest-to-occupant position SP_{B} may be a position biased toward the boarding and alighting area 320 as viewed from the center of the road in which the stop area 310 has been provided, similar to the closest-to-entrance position SP_{A}. The closest-to-occupant position SP_{B} is an example of the “first stop position”.

Then, the action plan generator 140 determines whether an obstacle is present in front of the closest-to-occupant position SP_{B} on the basis of the recognition result of the recognizer 130 (step S114). The obstacle is an object that is expected to hinder travel of the host vehicle M when the travel of the host vehicle M stopped at the closest-to-occupant position SP_{B} is started from the closest-to-occupant position SP_{B}. Specifically, the obstacle is an object such as a second vehicle stopped in front of the closest-to-occupant position SP_{B} or an obstacle installed in front of the closest-to-occupant position SP_{B}.

When the action plan generator 140 has determined that there is no obstacle in front of the closest-to-occupant position SP_{B}, the action plan generator 140 generates a target trajectory from the current position of the host vehicle M to the closest-to-occupant position SP_{B}. In this case, the action plan generator 140 determines a position element and a speed element of the target trajectory such that the host vehicle M stops at the closest-to-occupant position SP_{B} at an angle at which the traveling direction of the host vehicle M does not intersect with the direction in which the road in which the stop area 310 has been provided extends, that is, an angle (an example of a second state) at which the traveling direction of the host vehicle M is substantially parallel to the direction in which the road in which the stop area 310 has been provided extends. Then, the second controller 160 stops the host vehicle M in a straight state at the closest-to-occupant position SP_{B} according to the target trajectory (step S116).

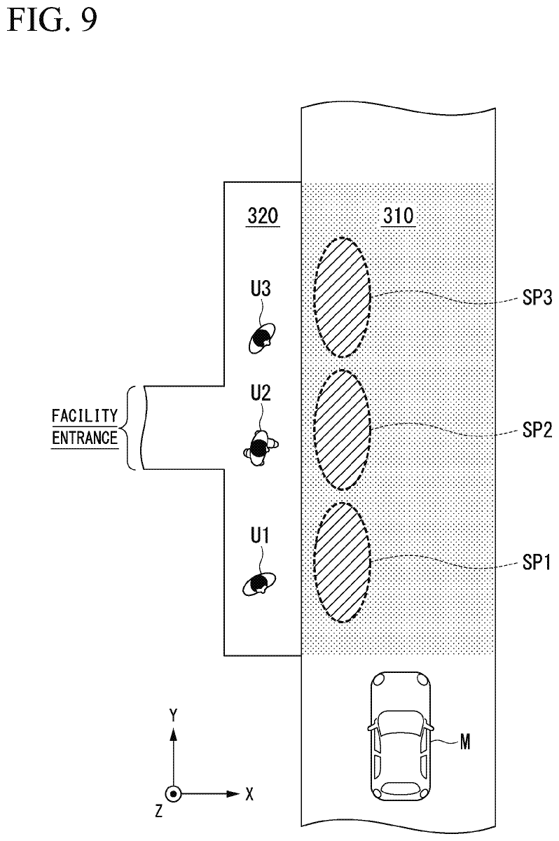

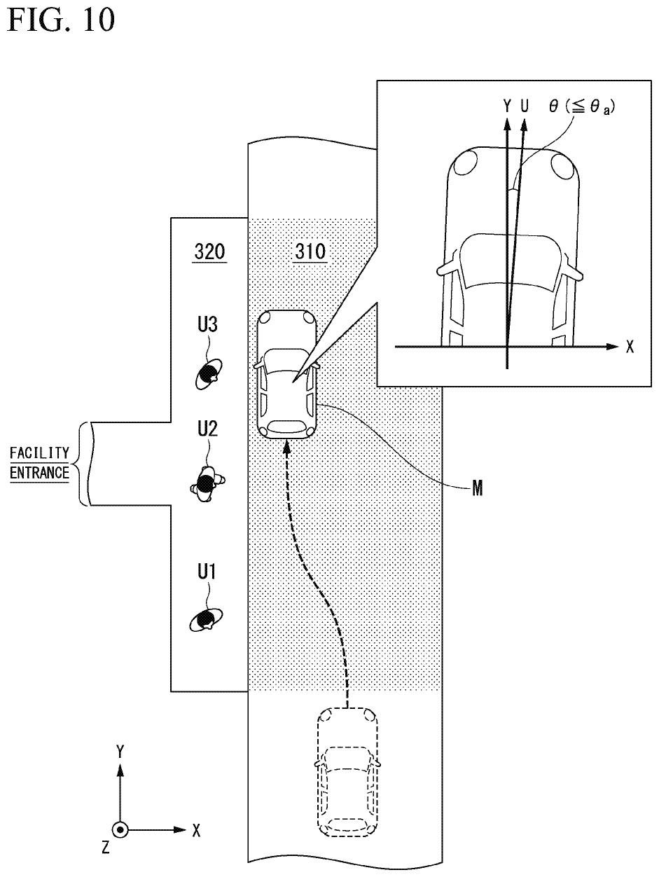

FIGS. 9 and 10 are diagrams schematically showing a state in which the host vehicle M is stopped at the closest-to-occupant position SP_{B}. In FIGS. 9 and 10, U1 to U3 indicate users who are waiting for a vehicle to arrive in the boarding and alighting area 320. In FIGS. 9 and 10, U indicates a traveling direction of the host vehicle M. Among the three users, the user U3 is recognized as an occupant of the host vehicle M by the recognizer 130. In such a case, the action plan generator 140 determines a position SP3 closest to the user U3 among three candidates for the stop position to be the closest-to-occupant position SP_{B}, and generates a target trajectory to the closest-to-occupant position SP_{B}. In this case, the action plan generator 140 generates the target trajectory such that an angle θ between the traveling direction U of the host vehicle M and a direction Y in which a road extends is equal to or smaller than a first threshold angle θ_{A}. The first threshold angle θ_{A} is preferably 0 degrees, but an error of about several degrees may be allowed. Thereby, the host vehicle M stops in a straight state in which a vehicle body is substantially parallel to the direction Y in which the road extends, within a predetermined distance from the user U3 recognized as the occupant of the host vehicle M.

When the action plan generator 140 determines that there is no obstacle ahead of the closest-to-occupant position SP_{B}, the action plan generator 140 determines whether or not the closest-to-occupant position SP_{B} is present in front of a second vehicle that has already stopped in the stop area 310. When the action plan generator 140 has determined that the closest-to-occupant position SP_{B} is present in front of the other stopped vehicle, the action plan generator 140 determines a position ahead of a current closest-to-occupant position SP_{B} to be a new closest-to-occupant position SP_{B} so that an inter-vehicle distance (a distance in a full length direction of the host vehicle M) between the host vehicle M and the second vehicle, which is a vehicle following the host vehicle M, increases after the host vehicle M is stopped at the closest-to-occupant position SP_{B}.

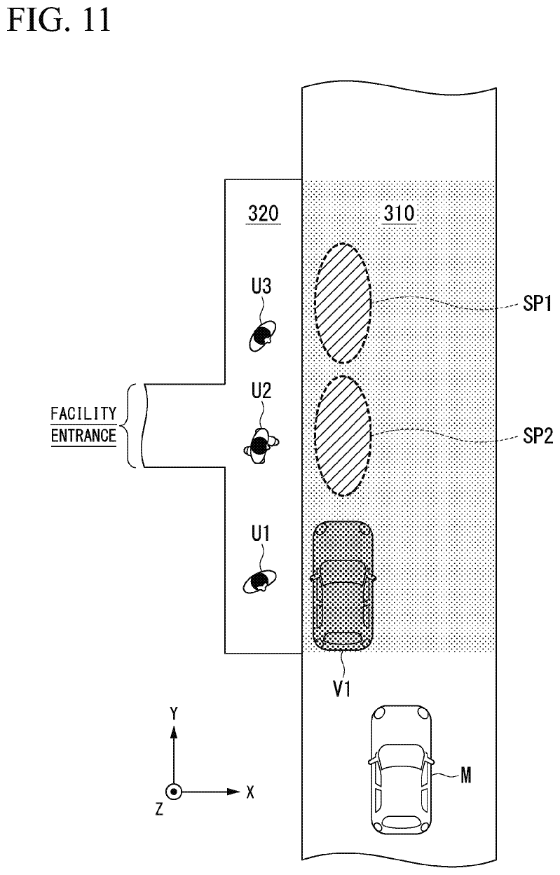

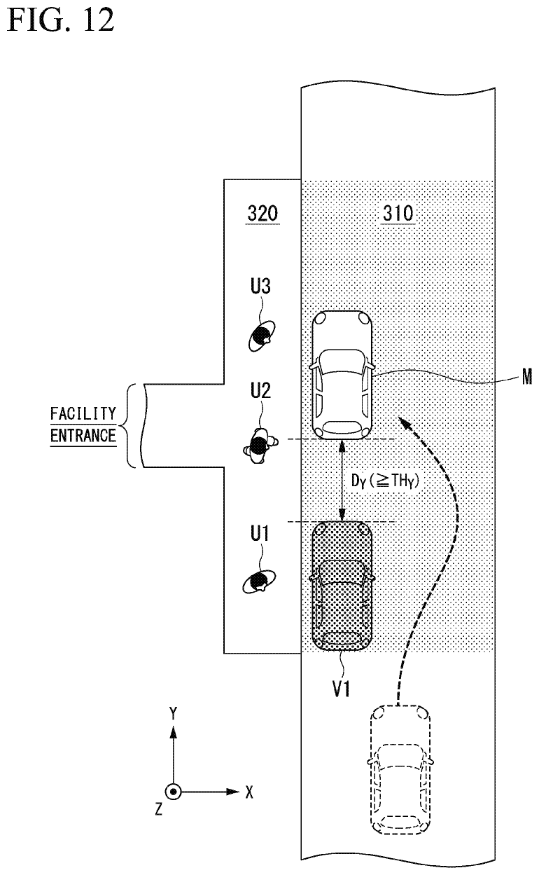

FIGS. 11 and 12 are diagrams schematically showing a state in which the host vehicle M is stopped at the closest-to-occupant position SP_{B}. V1 in FIGS. 11 and 12 indicates a certain other vehicle. In the shown example, a user U2 among three users is recognized as an occupant of the host vehicle M by the recognizer 130. In such a case, the action plan generator 140 determines the position SP2 closest to the user U2 to be the closest-to-occupant position SP_{B}, and determines that a second vehicle V1 is present behind the closest-to-occupant position SP_{B}. The action plan generator 140 determines a further forward position in the traveling direction to be a new closest-to-occupant position SP_{B}, as compared with a case in which the closest-to-occupant position SP_{B} is not a position in front of the second vehicle. Specifically, when the host vehicle M is stopped in front of the second vehicle V1, the action plan generator 140 determines a position at which an inter-vehicle distance D_{Y} with respect to the second vehicle V1 is equal to or greater than a first predetermined distance TH_{Y} to be the new closest-to-occupant position SP_{B}. Thus, since the host vehicle M is stopped at a position on the side of the occupant waiting in the boarding and alighting area 320, which is a position at which an inter-vehicle distance with respect to a following vehicle is long, it is easy for the occupant to board the host vehicle M, and since it becomes difficult for traveling of the following vehicle to be hindered, it is possible to make a traffic flow smooth.

The description of the flowcharts in FIGS. 5 and 6 will be referred back to. On the other hand, when the action plan generator 140 has determined that the obstacle is present in front of the closest-to-occupant position SP_{B}, the action plan generator 140 determines whether or not switching of a driving mode at the time of start of travel of the host vehicle M stopped at the closest-to-occupant position SP_{B} from the automated driving mode to the manual driving mode is made (step S118). That is, the action plan generator 140 determines whether or not the reservation of performing the manual driving mode at the time of start of travel of the host vehicle M stopped at the closest-to-occupant position SP_{B} is made.

For example, when the occupant in the host vehicle M operates the HMI 30 before the host vehicle M enters the parking lot PA to reserve switching from the automated driving mode to the manual driving mode when the occupant has boarded the host vehicle M that has exited the parking lot PA or when the occupant who has alighted from the host vehicle M operates a terminal device such as a mobile phone to reserve switching from the automated driving mode to the manual driving mode when the occupant has boarded the host vehicle M that has exited the parking lot PA, the action plan generator 140 determines that the reservation of switching between the driving modes at the time of start of travel of the host vehicle M to the manual driving mode has been made, that is, performing the manual driving mode has been determined in advance.

When a rule of the driving mode to be executed at the time of exiting the stop area 310 has been determined for each visit destination facility in advance, the action plan generator 140 may determine whether or not switching of the driving mode from the automated driving mode to the manual driving mode has been reserved on the basis of the rule. For example, it is assumed that, when the host vehicle M exits from the stop area 310 in a certain visit destination facility A, it is determined as a rule that the host vehicle M is in the automated driving mode, and when the host vehicle M exits from the stop area 310 in another visit destination facility B, it is determined as a rule that the host vehicle M is in the manual driving mode. In such a case, when the host vehicle M exits from the stop area 310 of the visit destination facility A, the action plan generator 140 determines that the reservation has not been made to switch the driving mode from the automated driving mode to the manual driving mode, and determines that a reservation has been made to switch the driving mode from the automated driving mode to the manual driving mode when the host vehicle M exits from the stop area 310 of the visit destination facility B.

When the action plan generator 140 has determined that the reservation of switching between the driving modes at the time of start of travel of the host vehicle M to the manual driving mode is not made, that is, when the automated driving mode is continuously executed, the process proceeds to S116. Thereby, the host vehicle M stops in a state straight to the occupant.

On the other hand, when the action plan generator 140 has determined that the reservation of switching between the driving modes at the time of start of travel of the host vehicle M to the manual driving mode is made, that is, when performing the manual driving is determined in advance and the occupant intends to perform the manual driving, the action plan generator 140 determines a position element and a speed element of the target trajectory so that the host vehicle M stops at the closest-to-occupant position SP_{B} at an angle (an example of the first state) at which the traveling direction of the host vehicle M intersects with the direction in which the road in which the stop area 310 has been provided extends. Then, the second controller 160 stops the host vehicle M in a state oblique to the closest-to-occupant position SP_{B} according to the target trajectory (step S120). The mode switching controller 182 switches the driving mode from the automated driving mode to the manual driving mode, and ends the process of the flowchart.

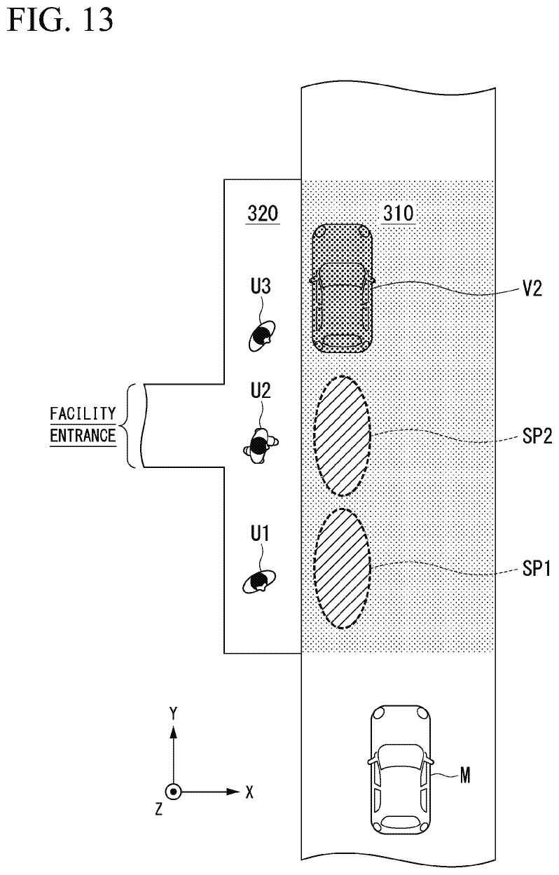

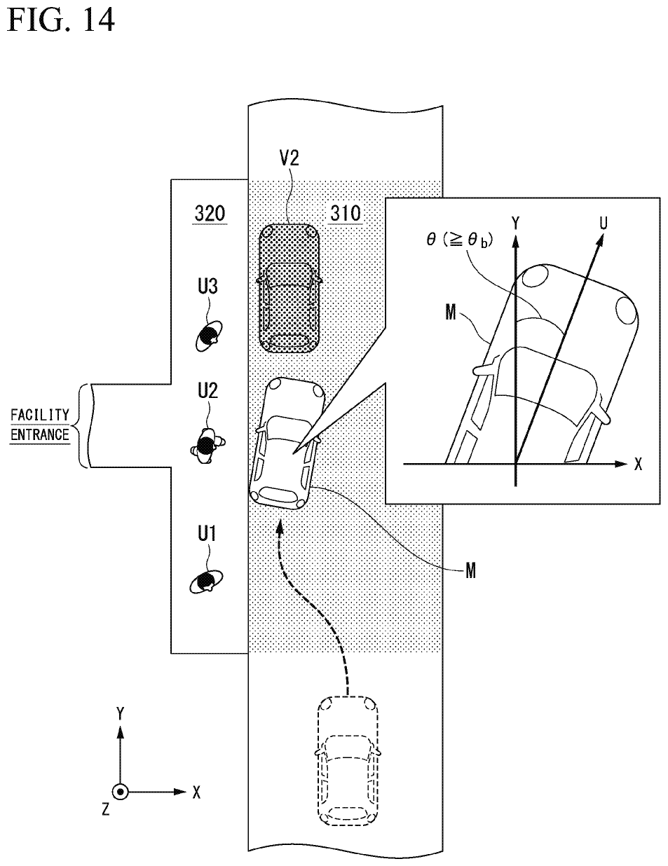

FIGS. 13 and 14 are diagrams schematically showing a state in which the host vehicle M is stopped at the closest-to-occupant position SP_{B}. As shown in the example, a second vehicle V2 has already stopped near a user U3 at a point in time when the host vehicle M has arrived at the stop area 310. A user U2 among three users shown in FIGS. 13 and 14 is recognized as an occupant of the host vehicle M by the recognizer 130. In such a case, the action plan generator 140 determines a position SP2 closest to the user U2 among three candidates for the stop position to be the closest-to-occupant position SP_{B}, and generates a target trajectory to the closest-to-occupant position SP_{B}. In this case, the action plan generator 140 generates the target trajectory so that the angle θ between the traveling direction U of the host vehicle M and the direction Y in which the road extends is equal to or greater than a second threshold angle θ_{B}. The second threshold angle θ_{B} is an angle larger than the first threshold angle θ_{A}. For example, the second threshold angle θ_{B} may be several degrees such as 5 degrees or 7 degrees, may be ten and several degrees such as 12 degrees or 15 degrees, or may be tens of degrees such as 20 degrees or 30 degrees.

When the boarding and alighting area 320 faces the left hand side of the stop area 310 and the host vehicle M is stopped on the left side of the road in which the stop area 310 has been provided as shown in FIGS. 13 and 14, the action plan generator 140 generates a target trajectory such that the traveling direction U is inclined to the side of the stop area 310 that the boarding and alighting area 320 does not face, that is, the right hand side of the stop area 310. Thereby, the host vehicle M stops within a predetermined distance from the user U2 recognized as the occupant of the host vehicle M in a state in which a vehicle body is inclined with respect to the direction Y in which the road extends. Thus, in a case in which an obstacle is present in front of a stop position when the host vehicle M is stopped on the side of the occupant and the occupant is scheduled to manually drive the host vehicle M after boarding, the host vehicle M is stopped in an obliquely inclined state. Thus, it is possible to omit an operation of turning the steering wheel by the occupant when the host vehicle M escapes from a parallel parking state. As a result, the occupant can easily escape from the parallel parking state.

The description of the flowcharts in FIGS. 5 and 6 will be referred back to. Then, the action plan generator 140 determines whether or not the occupant has boarded the host vehicle M after the host vehicle M has been stopped in the stop area 310 (step S122). When the action plan generator 140 has determined that the occupant does not board the host vehicle M, the action plan generator 140 determines whether or not a first predetermined time has elapsed after the host vehicle M has been stopped in the stop area 310 (step S124). The first predetermined time may be, for example, about tens of seconds to several minutes.

When the occupant does not board the host vehicle M and the first predetermined time has elapsed after the host vehicle M has been stopped in the stop area 310, the action plan generator 140 generates a target trajectory to a stop position located at a most forward position in a traveling direction in the stop area 31 (hereinafter referred to as a leading stop position SP_{C}). Then, the second controller 160 moves the host vehicle M to the leading stop position SP_{C} according to the target trajectory and stops the host vehicle M at the leading stop position SP_{C} (step S126). The leading stop position SP_{C} is an example of a “third stop position”.

For example, it is possible to determine that the occupant of the host vehicle M is misidentified when the user present in the boarding and alighting area 320 has been recognized as the occupant of the host vehicle M, but the occupant does not board the host vehicle M until the first predetermined time elapses. In a case in which an original occupant is present in the boarding and alighting area 320 even when the occupant is misidentified and the host vehicle M stops on the side of another person different from the original occupant, it is conceivable that the occupant moves by itself and boards the host vehicle M. Therefore, even when the host vehicle M stops at a wrong position, it is possible to determine that the original occupant of the host vehicle M is present in the boarding and alighting area 320 in a case in which the occupant boards the host vehicle M until the first predetermined time elapses, and it is possible to determine that the original occupant of the host vehicle M is not present in the boarding and alighting area 320 in a case in which the occupant does not board the host vehicle M until the first predetermined time elapses.

That is, in a case in which the user present in the boarding and alighting area 320 has been recognized as the occupant of the host vehicle M, but the occupant does not board the host vehicle M until the first predetermined time elapses, it is possible to determine that another person present in the boarding and alighting area 320 has been recognized as the occupant of the host vehicle M when the occupant of the host vehicle M has not yet arrived at the boarding and alighting area 320.

Even when the host vehicle M has stopped on the side of the original occupant without misidentification of the occupant, it is possible to determine that the person has returned to the visit destination facility from the boarding and alighting area 320 when the occupant does not board the host vehicle M until the first predetermined time elapses.

In such a case, when another user present in the boarding and alighting area transmits a vehicle pick-up request to call his or her vehicle to the stop area 310, the host vehicle M may hinder pick-up of a second vehicle. Therefore, the action plan generator 140 generates a target trajectory to the leading stop position SP_{C} at which the pick-up of the second vehicle is not hindered, and the second controller 160 moves and stops the host vehicle M to and at the leading stop position SP_{C} according to the target trajectory. Thereby, it is possible to make a traffic flow smooth while securing a pick-up space for the second vehicle in the stop area 310.

Then, the action plan generator 140 determines whether or not the occupant has boarded the host vehicle M after the host vehicle M has been stopped at the leading stop position SP_{C} (step S128). When the action plan generator 140 has determined that the occupant does not board the host vehicle M, the action plan generator 140 determines whether or not a second predetermined time has elapsed after the host vehicle M has stopped at the leading stop position SP_{C} (step S130). The second predetermined time may be a time that is the same as the first predetermined time, or may be a time different from the first predetermined time. For example, the second predetermined time may be about several minutes, or may be about tens of minutes.

When the action plan generator 140 has determined that the second predetermined time has elapsed, the action plan generator 140 generates a target trajectory from the stop area 310 to the parking lot PA. Then, the second controller 160 moves the host vehicle M to the parking lot PA according to the target trajectory, and parks the host vehicle M in the parking space PS of the parking lot PA (step S132). In this case, the action plan generator 140 may control the communication device 20 so that information indicating that the host vehicle M has returned to the parking lot PA due to the fact that vehicle pick-up could not be made is transmitted to the terminal device, which is a transmission source of the vehicle pick-up request. Thus, when the host vehicle M is stopped at the leading stop position SP_{C} and waits, but the occupant does not board the host vehicle M until the second predetermined time elapses, the host vehicle M is parked again in the parking lot PA in which the host vehicle M was originally located, thereby curbing hindrance pick-up of a second vehicle by the host vehicle M.

On the other hand, when the occupant boards the host vehicle after the host vehicle M has been stopped at any position in the stop area 310, the action plan generator 140 determines whether there is another stopped vehicle ahead of the host vehicle M on the basis of the recognition result of the recognizer 130 (step S134).

When the action plan generator 140 has determined that no other stopped vehicle is present in front of the host vehicle M, the action plan generator 140 generates a target trajectory from the stop position biased toward one side of the road, in which the stop area 310 has been provided, to the center of the road. Then, the second controller 160 controls steering and a speed of the host vehicle according to the target trajectory, so that the host vehicle M exits the stop area 310 while traveling along the center of the road.

On the other hand, when the action plan generator 140 has determined that there is another stopped vehicle in front of the host vehicle M, the action plan generator 140 determines whether or not one or more persons are present around the other stopped vehicle on the basis of the recognition result of the recognizer 130 (step S136). “Around the second vehicle” is, for example, a range within several meters from the second vehicle. This range may include the inside of the second vehicle. That is, the action plan generator 140 may determine whether or not there are one or more persons around the second vehicle, including the inside of the other stopped vehicle.

For example, when the action plan generator 140 has acquired, from the recognizer 130, a recognition result (an example of a fourth recognition result) indicating that one or a plurality of persons have been recognized around a second vehicle, the action plan generator 140 determines that one or more persons are present around the other stopped vehicle.

For example, when the action plan generator 140 has acquired, from the recognizer 130, a recognition result (an example of a fifth recognition result) indicating that no person has been recognized around the second vehicle, the action plan generator 140 determines that one or more persons are not present around the other stopped vehicle. For example, when the action plan generator 140 has not been acquired, from the recognizer 130, the recognition result indicating that one or a plurality of persons have been recognized around the second vehicle until a predetermined period has elapsed after the host vehicle M has been stopped in the stop area 310, the action plan generator 140 may determine that one or more persons are not present around the other stopped vehicle.

When the action plan generator 140 has determined that there is the other stopped vehicle in front of the host vehicle M and there is no person around the other stopped vehicle, the action plan generator 140 generates a target trajectory for causing the host vehicle M to overtake the other stopped vehicle. Then, the second controller 160 controls the steering and the speed of the host vehicle according to the target trajectory so that the host vehicle M overtakes the other stopped vehicle (step S138).

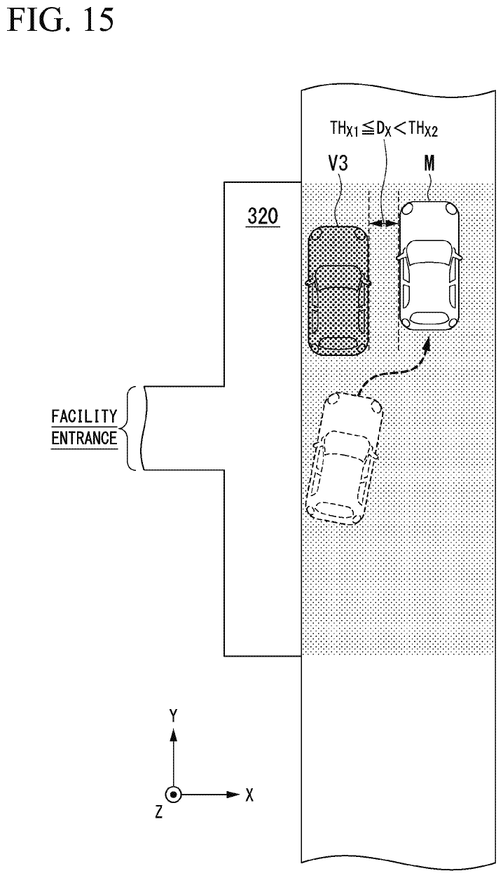

FIG. 15 is a diagram schematically showing a state in which the host vehicle M is caused to overtake the other stopped vehicle. In the shown example, no user is present around the second vehicle V3. In such a case, when the host vehicle M overtakes the second vehicle V3, the action plan generator 140 determines a distance D_{X} between the host vehicle M and the second vehicle V3 in the vehicle width direction to be in a range (TH_{X1}≤DX<TH_{X2}) that is equal to or greater than a second predetermined distance TH_{X1} and smaller than a third predetermined distance TH_{X2} that is greater than the second predetermined distance TH_{X1}.

On the other hand, when the action plan generator 140 has determined that there is another stopped vehicle in front of the host vehicle M and there is a person around the other stopped vehicle, the action plan generator 140 generates a target trajectory for causing the host vehicle M to overtake the other stopped vehicle. In this case, the action plan generator 140 generates a target trajectory for moving the host vehicle further away from the second vehicle, as compared with a case in which no person is present around the other stopped vehicle. Then, the second controller 160 controls steering and speed of the host vehicle according to the target trajectory, thereby causing the host vehicle M to overtake the other stopped vehicle while moving the host vehicle M further away from the other stopped vehicle, as compared with a case in which no person is present around the other stopped vehicle (step S140). Thereby, the process of the flowchart ends.

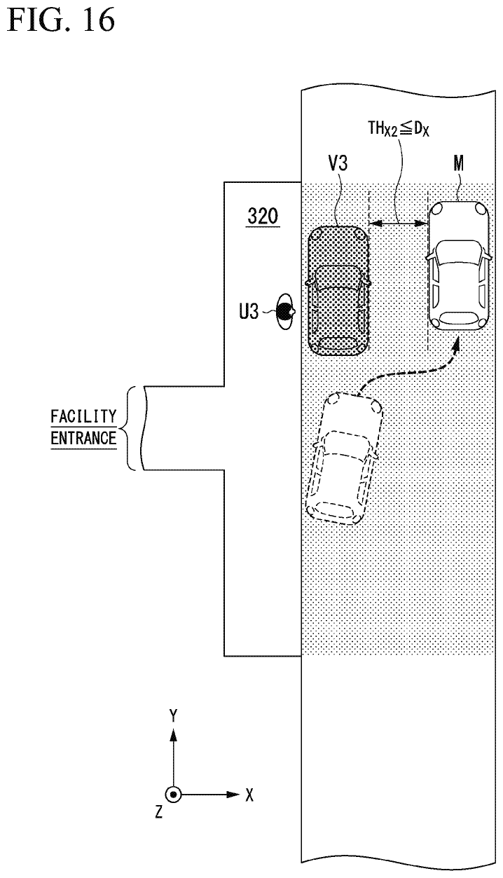

FIG. 16 is a diagram schematically showing a state in which the host vehicle M is caused to overtake another stopped vehicle. In the shown example, a user U3 is present around a second vehicle V3. In such a case, when the host vehicle M overtakes the second vehicle V3, the action plan generator 140 determines a distance D_{X} between the host vehicle M and the second vehicle V3 in a vehicle width direction to be equal to or greater than the third predetermined distance TH_{X2} (TH_{X2}≤D_{X}).

For example, when the second vehicle V3 is stopped in the stop area 310, the second vehicle V3 can determine that the user U3 in the boarding and alighting area 320 waits for boarding, similar to the host vehicle M. Therefore, it is assumed that the user U3 present around the other stopped vehicle V3 is likely to be an occupant of the second vehicle V3, and the user U3 will enter the stop area 310 and open a door on the side other than the side of the boarding and alighting area 320 or suddenly jump out on the road in order to board the second vehicle V3 or load luggage into the second vehicle V3.

Accordingly, the action plan generator 140 moves the host vehicle M away from the other stopped vehicle when the host vehicle M is caused to overtake the other stopped vehicle in a situation in which a person is present around the other stopped vehicle and it is easy for any action or work to be performed around the second vehicle, as compared with a situation in which a person is not present around the second vehicle and it is difficult for any action or work to be performed around the second vehicle.

The action plan generator 140 may further decrease the speed of the host vehicle M instead of or in addition to further increasing the distance D_{X} between the host vehicle M and the second vehicle V3 in the vehicle width direction when the host vehicle M overtakes the other stopped vehicle V3. A period in which the action plan generator 140 decreases the speed may be, for example, a period in which the host vehicle M overtakes the second vehicle V3 from behind the second vehicle V3 and reaches an area in front of the second vehicle V3. Thus, it is possible to cause the host vehicle to safely exit the stop area 310 by moving the host vehicle M away from the second vehicle or decreasing the speed of the host vehicle M when the host vehicle M overtakes the second vehicle.

According to the embodiment described above, the vehicle system 1 includes the recognizer 130 that recognizes the surroundings situation of the host vehicle M, the action plan generator 140 that generates the target trajectory on the basis of the surroundings situation of the host vehicle M recognized by the recognizer 130, and the second controller 160 that controls the steering and the speed of the host vehicle M on the basis of the target trajectory generated by the action plan generator 140 so that the host vehicle M is stopped at the stop area 310 facing the boarding and alighting area 320 in which the occupant of the host vehicle M waits. When the host vehicle M is moved to the stop area 310, the second controller 160 causes the host vehicle M to stop at the closest-to-occupant position SP_{B} at which the distance between the occupant and the host vehicle M is within a predetermined distance in the stop area 310 in a case in which the recognizer 130 has recognized the occupant in the boarding and alighting area 320, and causes the host vehicle M to stop at the closest-to-entrance position SP_{A} closest to the entrance of the visit destination facility in the stop area 310 in a case in which the recognizer 130 has not recognized the occupant in the boarding and alighting area 320 when the second controller 160 causes the host vehicle M to stop in the stop area 310. Thereby, it is possible to move the host vehicle M to a position at which it is easy for the user to board the host vehicle M and make a traffic flow smooth.

According to the embodiment described above, a stop position of the host vehicle M in the stop area 310 is determined according to an arrival order indicating whether the host vehicle M arrives at the stop area 310 before the occupant arrives at the boarding and alighting area 320 or the occupant arrives at the boarding and alighting area 320 before the host vehicle M arrives at the stop area 310. Thereby, in any case, it is possible to cause the host vehicle M to stop at a position at which it is easy for the user to board the host vehicle M.

### Other Embodiments

Hereinafter, other embodiments (modification examples) will be described. In the embodiment described above, a case in which, when the occupant does not board the host vehicle M and the first predetermined time has elapsed after the host vehicle M is stopped at the closest-to-entrance position SP_{A} or the closest-to-occupant position SP_{B}, the host vehicle M is moved to the leading stop position SP_{C} has been described, but the present invention is not limited thereto.

For example, when the occupant does not board the host vehicle M and the first predetermined time has elapsed after the host vehicle M is stopped at the closest-to-entrance position SP_{A} or the closest-to-occupant position SP_{B}, the automated driving control device 100 may move the host vehicle M to a stop position immediately ahead of the stop position at which the host vehicle M is currently stopped among one or more stop positions that are candidates for the closest-to-entrance position SP_{A} or the closest-to-occupant position SP_{B}.

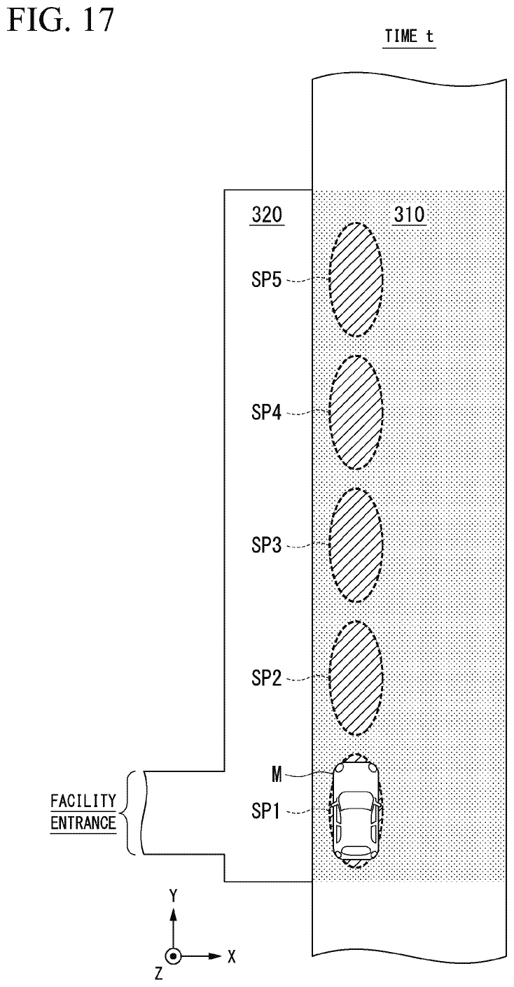

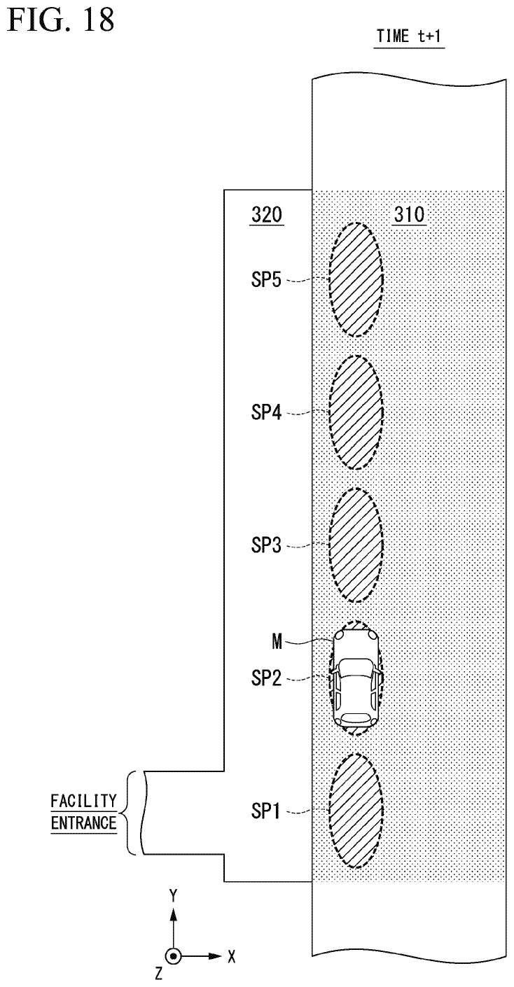

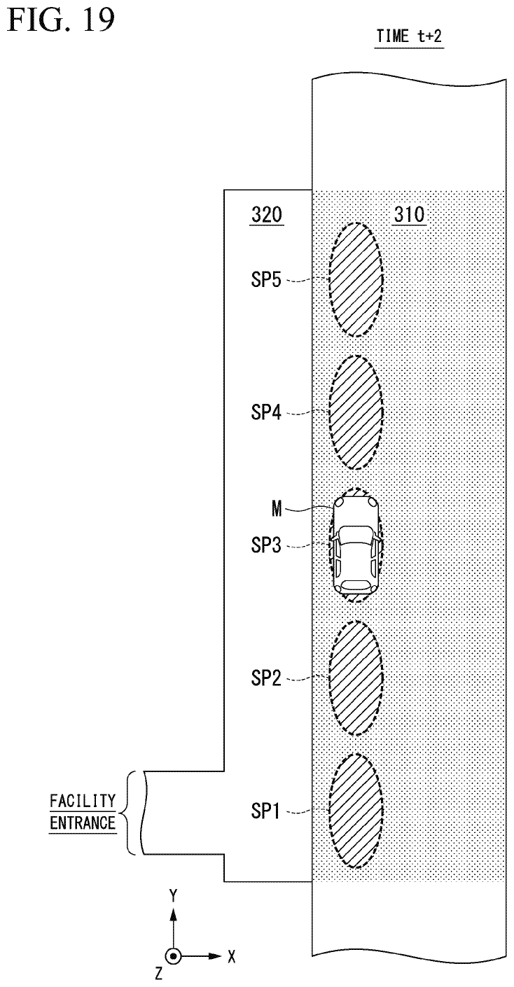

FIGS. 17 to 19 are diagrams schematically showing a state in which a stop position of the host vehicle M is changed in the stop area 310. FIG. 17 shows a scene in a certain time t, FIG. 18 shows a scene in time t+1 after time t, and FIG. 19 shows a scene in time t+2 after time t+1. In any case, because no user is present in the boarding and alighting area 320, the recognizer 130 does not recognize the occupant of the host vehicle M in the boarding and alighting area 320. In this case, the action plan generator 140 determines a position SP1 closest to a visit destination facility among five candidates for the stop position SP1 to SP5 as shown in the scene in time t, as the closest-to-entrance position SP_{A}, and generates a target trajectory to the closest-to-entrance position SP_{A}. Then, the second controller 160 stops the host vehicle M at the position SP1 according to the target trajectory.

For example, when the occupant does not board the host vehicle M and the first predetermined time has elapsed after the host vehicle M has stopped at the position SP1, the action plan generator 140 determines the position SP2 immediately ahead of the position SP1 determined to be the closest-to-entrance position SP_{A} in a point in time t among the four remaining stop positions that have been candidates for the closest-to-entrance position SP_{A} at the point in time t as shown in the scene at the time t+1, to be a new closest-to-entrance position SP_{A}. Then, the second controller 160 stops the host vehicle M at the position SP2 according to the target trajectory.

For example, when the occupant does not board the host vehicle M and the first predetermined time further elapses after the host vehicle M stops at the position SP2, the action plan generator 140 determines the position SP3 immediately ahead of the position SP2 determined to be a candidate for the closest-to-entrance position SP_{A} at a point in time t+1 among the three remaining stop positions, which are candidates for the closest-to-entrance position SP_{A} at time t+1, as shown in a scene in time t+2, to be a new entrance nearest position SP_{A}. Then, the second controller 160 stops the host vehicle M at the position SP3 according to the target trajectory.

Thus, when the occupant does not board the host vehicle M until the first predetermined time elapses after the action plan generator 140 stops the host vehicle M at the closest-to-entrance position SP_{A}, the action plan generator 140 changes the closest-to-entrance position SP_{A} to a forward position in the traveling direction in the stop area 310 each time the first predetermined time elapses until the occupant boards the host vehicle M, and the second controller 160 repeatedly moves the host vehicle M to the closest-to-entrance position SP_{A} changed each time the first predetermined time elapses and stops the host vehicle M at the closest-to-entrance position SP_{A}. Thus, it is possible to make a traffic flow smooth while securing a pick-up space for the second vehicle in the stop area 310.

In the embodiment described above, a case in which the recognizer 130 of the automated driving control device 100 mounted in the host vehicle M recognizes the surroundings situation of the host vehicle M has been described, but the present invention is not limited thereto. For example, an external recognition device 500 installed in a site of the visit destination facility may recognize the surroundings situation of the host vehicle M. The external recognition device 500 is an example of a “second recognition device”.

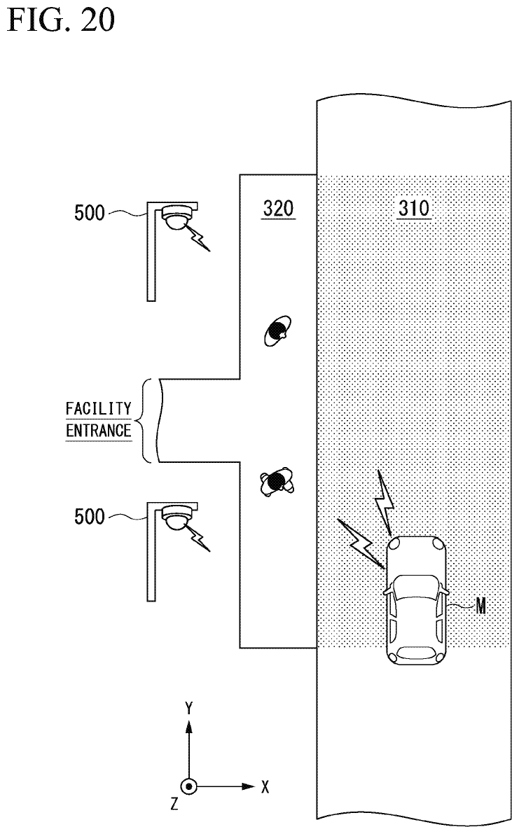

FIG. 20 is a diagram schematically showing a state in which the automated driving control device 100 controls the host vehicle M using a recognition result of the external recognition device 500. The external recognition device 500 is, for example, infrastructure equipment installed in the site of the visit destination facility. Specifically, the external recognition device 500 includes infrastructure equipment such as cameras, radars, and infrared sensors that monitor the boarding and alighting area 320 or the stop area 310.

When the host vehicle M is moved to the stop area 310, the action plan generator 140 communicates with the external recognition device 500 via the communication device 20, and acquires information indicating various recognition results such as presence or absence, the number, and a position of users present in the boarding and alighting area 320 from the external recognition device 500. The action plan generator 140 generates a target trajectory on the basis of the acquired information. Thereby, even when the automated driving control device 100 itself does not recognize the surroundings situation, the automated driving control device 100 can automatically stop the host vehicle M at a position at which it is easy for the user to board using the recognition results of the external recognition device 500 installed in the site of the visit destination facility.

### [Hardware Configuration]

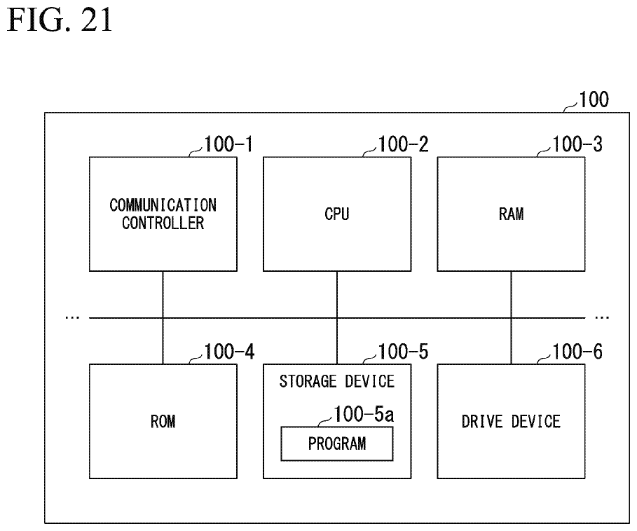

FIG. 21 is a diagram showing an example of a hardware configuration of the automated driving control device 100 according to the embodiment. As shown in FIG. 14, the automated driving control device 100 has a configuration in which a communication controller 100-1, a CPU 100-2, a RAM 100-3 that is used as a working memory, a ROM 100-4 that stores a boot program or the like, a storage device 100-5 such as a flash memory or an HDD, a drive device 100-6, and the like are connected to each other by an internal bus or a dedicated communication line. The communication controller 100-1 communicates with components other than the automated driving control device 100. A program 100-5a to be executed by the CPU 100-2 is stored in the storage device 100-5. This program is developed in the RAM 100-3 by a direct memory access (DMA) controller (not shown) or the like and executed by the CPU 100-2. Thereby, one or both of the first controller 120, the second controller 160, and the third controller 180 are realized.

The embodiment described above can be represented as follows.

A vehicle control device including a storage that stores a program; and a processor, and configured to acquire a recognition result of a surroundings situation of a vehicle from a recognition device configured to recognize the surroundings situation of the vehicle, control steering and a speed of the vehicle on the basis of the acquired recognition result to move the vehicle so that a user located in a boarding area is able to board the vehicle, stop the vehicle at a first stop position based on a position of the user in the boarding area in a case in which the user has been recognized in the boarding area by the recognition device when the vehicle is moved to the boarding area, and stop the vehicle at a second stop position based on a position of an entrance to a facility in the boarding area in a case in which the user has not been recognized in the boarding area by the recognizer when the vehicle is moved to the boarding area, by the processor executing the program.

While forms for carrying out the present invention have been described using the embodiments, the present invention is not limited to these embodiments at all, and various modifications and substitutions can be made without departing from the gist of the present invention.

What is claimed is:

1. A vehicle control device comprising:
an acquirer configured to acquire a recognition result of a surroundings situation of a vehicle from a recognition device configured to recognize the surroundings situation of the vehicle; and
a driving controller configured to control steering and a speed of the vehicle on the basis of the recognition result acquired by the acquirer, to move the vehicle so that a user located in a boarding area is able to board the vehicle,
wherein the driving controller
is configured to stop the vehicle at a first stop position according to a position of the user in the boarding area in a case in which a first recognition result indicating that the user has been recognized in the boarding area has been acquired by the acquirer when the vehicle is moved to the boarding area, and
is configured to stop the vehicle at a second stop position according to a position of an entrance to a facility in the boarding area in a case in which a second recognition result indicating that the user has not been recognized in the boarding area has been acquired by the acquirer or in a case in which the first recognition result has not been acquired by the acquirer when the vehicle is moved to the boarding area.

2. The vehicle control device according to claim 1, wherein the driving controller is configured to determine a position at which a distance between the user and the vehicle is within a predetermined distance in the boarding area to be the first stop position.

3. The vehicle control device according to claim 1, wherein, in a case in which the acquirer has acquired a third recognition result indicating that an obstacle present ahead of the first stop position, the obstacle being an obstacle predicted to hinder travel of the vehicle when travel of the vehicle from the first stop position is started, has been recognized when the vehicle is stopped at the first stop position, the driving controller is configured to stop the vehicle at the first stop position in a first state in which a traveling direction of the vehicle intersects a direction in which a road on which the boarding area is present extends.

4. The vehicle control device according to claim 3, wherein, when a driving mode of the vehicle scheduled when travel of the vehicle from the first stop position is started is a manual driving mode in which steering and a speed of the vehicle are controlled by the user, the driving controller is configured to stop the vehicle at the first stop position in the first state.

5. The vehicle control device according to claim 3, wherein, when a driving mode of the vehicle scheduled when travel of the vehicle from the first stop position is started is an automated driving mode in which steering and a speed of the vehicle are controlled, the driving controller is configured to stop the vehicle at the first stop position in a second state in which the traveling direction of the vehicle does not intersect with the direction in which the road extends, unlike the first state.

6. The vehicle control device according to claim 1,
wherein the recognition device is configured to recognize a surroundings situation of a second vehicle stopping in the boarding area, and
when the vehicle overtakes the second vehicle after travel of the vehicle from the first stop position has been started, the driving controller is configured to determine a distance in a vehicle width direction between the vehicle and the second vehicle when the vehicle is caused to overtake the second vehicle on the basis of the surroundings situation of the second vehicle indicated by the recognition result.

7. The vehicle control device according to claim 6, wherein, in a case in which the acquirer has acquired a fourth recognition result indicating that a person is present around the second vehicle, including the inside of the second vehicle, the driving controller increases the distance in the vehicle width direction, as compared with a case in which the acquirer has acquired a fifth recognition result indicating that no persons are present around the second vehicle, including the inside of the second vehicle or a case in which the acquirer has not acquired the fourth recognition result.

8. The vehicle control device according to claim 1,
wherein the recognition device is configured to recognize a surroundings situation of a second vehicle stopping in the boarding area, and
when the vehicle overtakes the second vehicle after travel of the vehicle from the first stop position has been started, the driving controller is configured to determine a speed of the vehicle when the vehicle is caused to overtake the second vehicle on the basis of the surroundings situation of the second vehicle indicated by the recognition result.

9. The vehicle control device according to claim 8, wherein, in a case in which the acquirer has acquired a fourth recognition result indicating that a person is present around the second vehicle, including the inside of the second vehicle, the driving controller decreases the speed of the vehicle, as compared with a case in which the acquirer has acquired a fifth recognition result indicating that no persons are present around the second vehicle, including the inside of the second vehicle or a case in which the acquirer has not acquired the fourth recognition result.

10. The vehicle control device according to claim 1, wherein, when the user does not board the vehicle until a first predetermined time elapses after the vehicle is stopped at the first stop position, the driving controller is configured to move the vehicle to a third stop position, the third stop position being a leading position in the boarding area and stopping the vehicle.

11. The vehicle control device according to claim 10, wherein, when the user does not board the vehicle until a second predetermined time elapses after the vehicle is stopped at the third stop position, the driving controller is configured to move the vehicle to a parking lot and parks the vehicle.

12. The vehicle control device according to claim 1, wherein the driving controller is configured to determine a further forward position in a traveling direction when the first stop position is present in front of the second vehicle stopping in the boarding area than when the first stop position is not present in front of the second vehicle, to be the first stop position.

13. The vehicle control device according to claim 1, wherein, when the user does not board the vehicle after the vehicle is stopped at the second stop position, the driving controller repeatedly is configured to move the vehicle to a forward area in the boarding area and stop the vehicle until the user boards the vehicle.

14. The vehicle control device according to claim 1,
wherein the boarding area includes a first area in which the user waits, and a second area in which the user is able to board the vehicle, and
the driving controller is configured to move the vehicle to the second area.

15. The vehicle control device according to claim 1, wherein the recognition device includes at least one of a first recognition device mounted in the vehicle and a second recognition device installed in a site of a facility including the boarding area.

16. A vehicle control method comprising:
acquiring, by a computer mounted in a vehicle, a recognition result of a surroundings situation of the vehicle from a recognition device configured to recognize the surroundings situation of the vehicle;
controlling, by the computer, steering and a speed of the vehicle on the basis of the acquired recognition result, to move the vehicle so that a user located in a boarding area is able to board the vehicle;
stopping, by the computer, the vehicle at a first stop position according to a position of the user in the boarding area in a case in which a first recognition result indicating that the user has been recognized in the boarding area has been acquired when the vehicle is moved to the boarding area, and
stopping, by the computer, the vehicle at a second stop position according to a position of an entrance to a facility in the boarding area in a case in which a second recognition result indicating that the user has not been recognized in the boarding area has been acquired or in a case in which the first recognition result has not been acquired when the vehicle is moved to the boarding area.

17. A non-transitory computer-readable storage medium storing a program, the program causing a computer mounted in a vehicle to execute:
acquiring a recognition result of a surroundings situation of the vehicle from a recognition device configured to recognize the surroundings situation of the vehicle;
controlling steering and a speed of the vehicle on the basis of the acquired recognition result, to move the vehicle so that a user located in a boarding area is able to board the vehicle;
stopping the vehicle at a first stop position according to a position of the user in the boarding area in a case in which a first recognition result indicating that the user has been recognized in the boarding area has been acquired when the vehicle is moved to the boarding area, and
stopping the vehicle at a second stop position according to a position of an entrance to a facility in the boarding area in a case in which a second recognition result indicating that the user has not been recognized in the boarding area has been acquired or in a case in which the first recognition result has not been acquired when the vehicle is moved to the boarding area.
